(19) United States
(12) Patent Application Publication
(10) Pub. No.: US 2008/0174598 A1
(43) Pub. Date: Jul. 24, 2008

(54) DESIGN VISUALIZATION SYSTEM, APPARATUS, ARTICLE AND METHOD

(76) Inventor: Max Risenhoover, Portland, OR (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 12/013,782

(22) Filed: Jan. 14, 2008

Related U.S. Application Data
(60) Provisional application No. 60/880,077, filed on Jan. 12, 2007.

(51) Int. Cl. G06T 15/00; G06F 15/16; G06F 15/173

(52) U.S. Cl. 345/419; 709/203; 709/226; 709/204

(57) ABSTRACT

A system, method, article and apparatus for design visualization is provided.

### CROSS-REFERENCE TO RELATED APPLICATIONS

This application claims the benefit of U.S. Provisional Application Ser. No. 60/880,077, filed on Jan. 12, 2007.

### FIELD

This application relates to computer aided design visualization.

### BACKGROUND

Visualizing proposed designs, such as but not limited to architectural, engineering or industrial designs, may be beneficial. For example, providing photo realistic or other renderings of proposed designs may assist in assessing design value and in making decisions about designs. However, photo realistic or other design renderings and visualizations are generally difficult to create due to workflow complexity, requiring user intervention at many steps during a design visualization process, and costly due to time and expertise involved in creating them. Current known visualization alternatives generally require human action and/or intervention to complete a number of manual tasks. Example known visualization methods include traditional sketches, scale models, and digital renderings created by teams of visualization specialists over weeks or months.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference to the following detailed description if read with the accompanying drawings in which:

FIG. 1 is a block diagram showing an embodiment of a design visualization system.

FIG. 2 is a flow chart showing a method of providing design visualizations in accordance with an embodiment.

FIG. 3 is a UML diagram showing example messaging interfaces, according to an embodiment.

FIG. 4 is a block diagram showing an example of a designer's workstation, according to an embodiment.

FIG. 5 is an example of information received by a design visualization system from a host application, according to an embodiment.

FIG. 6a is an example screen shot from a design visualization system embodiment with geographical coordinate specification capabilities.

FIG. 6b is an example screen shot from a design visualization system embodiment with capabilities to select and aggregate data from public domain and commercial providers, in accordance with an embodiment.

FIG. 7a is an example screen shot from a design visualization system showing a building floor plan rendered with a two-dimensional specification, in accordance with an embodiment.

FIG. 7b shows an example screen shot from a design visualization system showing a three dimensional rendering of the building depicted in FIG. 7a, in accordance with an embodiment.

FIG. 8 is a screen-shot from a design visualization system showing a stylized rendering, in accordance with an embodiment.

FIG. 9 is a block diagram showing an embodiment of a design visualization system.

FIG. 10 is a print-out showing an example “RenderRequest” message, in accordance with an embodiment.

FIG. 11 is a block diagram showing an embodiment of a design visualization system with multiple work groups.

FIG. 12 is a block diagram of an embodiment of a design visualization system.

FIG. 13 is a block diagram of an embodiment of a design visualization system with multiple work groups and viewing devices.

FIG. 14 is a block diagram illustrating a computer platform in accordance with an embodiment.

FIG. 15 is a print out of a screen shot from a design visualization system embodiment showing annotation capabilities.

FIG. 16 is a print out of a screen shot from a design visualization system embodiment with concurrent viewing capabilities.

FIGS. 17a-17c are print outs of example renderings from a design visualization system embodiment with real-time rendering capabilities, illustrating improvement in visual quality over time.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

Although claimed subject matter is not limited in scope in this respect, one particular embodiment provides a distributed system for design visualization. Designs may include, but are not limited to, architectural, engineering and/or industrial designs. The system may include a design visualization system that is capable of receiving one or more designs and/or design parameters from a first device, automatically delegating design tasks to local and/or remote compute nodes for rendering, and returning design renderings to the first device and/or to one or more viewing devices. In various embodiments, the design visualization system may delegate rendering tasks to nodes located in more than one location, and in this sense employ remote collaboration for creating design renderings. In various embodiments, the system may delegate rendering tasks based upon criteria, such as but not limited to, node latency, network throughput, and/or one or more characteristics of rendering tasks. In different embodiments, the system may provide specifications, such as but not limited to, material attributes, associations between CAD or other design application model elements and real-world materials, lighting attributes, associations between CAD or other design application model elements and real-world light sources, camera angles, camera range of motion and/or geographical coordinates, for use in creating the renderings. Output formats may vary in different embodiments, and may include, for example, still images, animations, presentation files, a file format suitable for an interactive media delivery platform, webpages, and/or interactive websites. Some embodiments may allow users from a second device and/or one or more viewing devices to edit renderings and/or control output displays.

In some embodiments, the design rendering system may include a data center. The data center may have a resource manager, storage manager and one or more workgroup managers. The resource manager may be capable of receiving designs and/or design parameters and rendering task requests from a first device, automatically delegating rendering tasks to one or more compute nodes for creating renderings, and outputting renderings to the first device and/or one or more viewing devices. The storage manager may be capable of storing design specifications and/or files. The workgroup manager may be capable of managing the compute nodes.

Various embodiments may be used by designers, such as but not limited to architects, engineers, interior designers, urban planners, real estate developers, or homeowners; or any user wishing to create a visualization of a proposed structure. Designers may employ CAD or other design applications to build models of a proposed design. However, claimed subject matter is not intended to be limited to these examples.

One embodiment, which may be called “PRiSM,” is a design visualization system which may employ workflow automation, interactivity, remote collaboration, and management of computing resources which may be employed by photon simulation algorithms in rendering visualizations. FRiSM may plug-in proprietary and/or third party rendering algorithms and may manage compute resources used by these algorithms to create renderings. PRiSM may manage multiple clusters of compute nodes that may be remotely coupled, such as by a WAN. The PRiSM™ system may apply a novel distributed enterprise software architecture to a field dominated by traditional desktop software. Many of the potentially time consuming manual tasks required by current rendering alternatives may be substantially reduced and/or eliminated with this embodiment due to automation, local and remote leveraged rendering processing capabilities, and/or the embodiment's ability to create renderings using one or more default settings that are based at least in part upon design context and/or one or more prior user design attribute selections for a project. This embodiment may allow a user who is not an experienced design rendering specialist to create and publish design visualizations without assistance from specialists. PRiSM™ is a trademark owned by m-six, Inc., world-wide rights reserved.

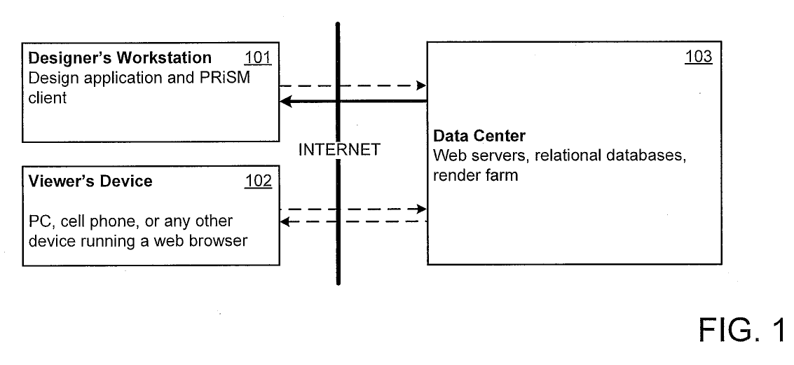

Although claimed subject matter is not so limited, for some embodiments, an architect or other designer may create a design at a computer or workstation, the design may be uploaded to a data center, computationally intensive rendering may take place on compute nodes located in one or more data centers supervised or controlled by a resource manager, and viewers may explore the rendered model from various web connected devices. FIG. 1 shows an embodiment of one system comprising a designer's workstation 101, a viewer's device 102 and a data center 103. In this embodiment, one or more design applications (such as but not limited to a CAD or other design application) and a PRiSM client may be located at the designer's workstation 101. The viewer's device 102 may be any device capable of viewing outputted renderings, such as but not limited to: a personal computer (PC), PDA, kiosk, cell phone, personal video device, or any other device running a web browser or other network connected graphics display software. There may be one or more viewer's devices 102 and in some embodiments, the designer's workstation 101 may comprise a viewer's device 102. Data center 103 may include web servers, relational databases and a render farm. Data center 103 may be remotely coupled to workstation 101 and device 102, such as by across the internet. Again, this is merely one embodiment and claimed subject matter is not intended to be limited to this example.

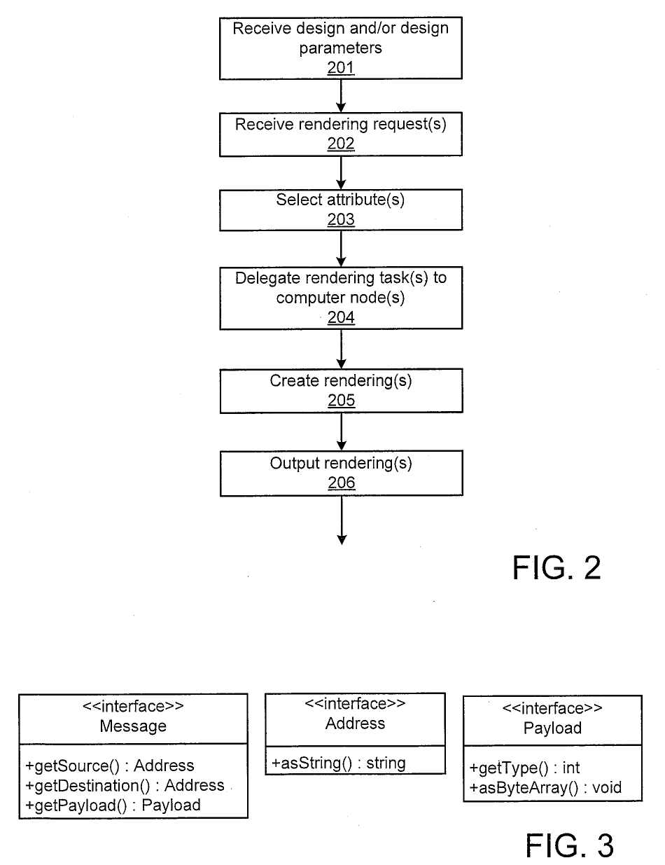

FIG. 2 shows an embodiment of a method of providing one or more design visualizations. At 201, one or more designs and/or design parameters may be received from a first device. For example, a design and/or design parameters may be received from a designer employing a CAD application at a workstation. However, this is but one example and claimed subject matter is not intended to be limited to this example. At 202, one or more rendering requests may be received from the first device. One or more design attributes may be selected, as shown at 203. Attributes may include, for example, material attributes, lighting attributes or camera attributes, based at least in part upon context of the design and/or design parameters, or one or more past attribute selections received from the first device and/or stored in a memory or library. In some embodiments, one or more default attributes may be automatically selected based at least in part upon context of the design and/or design parameters, or previous attribute selections based at least in part upon either other default selections or user selections. Block 204 shows that in this embodiment, one or more rendering tasks may be automatically delegated to one or more remotely coupled compute nodes, based at least in part upon the rendering requests. One or more design renderings may be created at 205 based at least in part upon the design and/or design parameters and attributes. The design renderings may be output at 206 to a first device and/or to one or more viewing devices.

Although claimed subject matter is not intended to be so limited, in one embodiment, the design visualization system may be comprised of cooperating subsystems. In some embodiments, connectivity between subsystems may be provided by an asynchronous messaging bus using publish/subscribe semantics. As described by its interface, a message may be simply a bundle of data consisting of a source address, destination address, and an arbitrary payload. Again, claimed subject matter is not intended to be limited to this particular example.

In one or more embodiments, messages may be sent from component to component to trigger the execution of tasks, deliver computed results, check permissions, etc. For example, PRiSM messages may be defined to allow the system to function without concern for the implementation details of exactly how messages are transmitted over a local network or the internet. In an embodiment, connectivity between subsystems may be provided by an asynchronous messaging bus using publish/subscribe semantics. As shown in FIG. 3, as described by its interface, a message may simply be a bundle of data consisting of a source address, destination address, and an arbitrary payload. For example, a message might be layered upon XML web services, might rely on a commercial product such as Tibco Rendezvous or IBM WebSphere MQ, or might be conveyed in any other suitable manner. For example, PRISM may mix and match messaging implementations depending upon changing market conditions and/or technical requirements. FIG. 3 shows a UML diagram of message interfaces used with a particular embodiment. Claimed subject matter is not intended to be limited to this particular example.

The design visualization system, in some embodiments, may be a network distributed system following a software-as-a-service model. In this type of embodiment, some or most of the “heavy lifting” may take place in a data center that is geographically remote from the users of the system. This is not a requirement, however. For example, a large firm with information technology infrastructure may elect to maintain data center functionality themselves. As such, “intranet” could be substituted for “internet” in this application. Again, this is merely one embodiment and claimed subject matter is not intended to be limited to this particular example.

Design visualization system functionality for some embodiments may be separated into three broad categories: design input, distributed processing, and model viewing. Design input may be functionality related to the various ways that a two or three-dimensional (2D or 3D) description of a structure can be ingested by the system and prepared for viewing. The structure might be, for example, a piece of furniture, an apparatus, a consumer product, a room, a building, a neighborhood, or a city. This list is not at all exhaustive of the myriad, broadly-defined structures capable of being rendered and viewed in accordance with the invention. Distributed processing may refer to network and data center functionality that may provide backend support for both design input and model viewing. Model viewing may be functionality allowing one or more viewers to visually explore and/or edit the model or control display.

In some embodiments, the design visualization system is not a design application. Rather, the design visualization system may ingest designs and/or design parameters and create various kinds of design visualizations. For example, the visualization system may employ an electronic description of a proposed structure created with an industry standard design tool. Example design tools may include: Autodesk AutoCAD, Autodesk Revit, Autodesk Inventor, Graphisoft ArchiCAD, Bentley Systems Microstation, Google SketchUp, Dassault Systemes SolidWorks, Dassault Systemes CATIA, or any other CAD or other design tool or application. In some embodiments, the design visualization system client may be a bridge between a designer's workstation and the rest of the distributed design visualization system. In various embodiments, the design visualization system client may be responsible for: launching and/or managing render tasks; translating geometrical scene descriptions from a proprietary format of a design application to a native format used by the design visualization system; specifying a real world location of the project using geographical coordinates; specifying material attributes; associating CAD or other design application model elements and real-world materials, specifying lighting attributes, associating CAD or other design application model elements and real-world light sources; and/or specifying camera positions and/or range of motion.

Some embodiments may deliver a product as an on-demand service, such as but not limited to SaaS (“software-as-a-service”) and/or ASP (“Application Service Provider”), which may remove costly infrastructure burdens in creating realistic or other architectural visualizations. Some embodiments may be models of software delivery in which the software company maintains the technical infrastructure, and users have network-based access to the functionality provided by the software. Various embodiments may remove complexity in creating renderings, which may allow designers to create their own visualizations rather than requiring the designers to rely on specialists.

In some embodiments, the design visualization system may plug-in to various applications, such as a CAD or other design application. In other embodiments, the design visualization system may be a stand alone system.

“Plug-in” embodiments may include interface/plug-in software type architecture. For example, embodiments may be implemented by use of C++, C#, and/or Java code. These types of code may have the notion of an interface (which in C++ may be referred to as an “Abstract Base Class”), a construct used to separate the public definition of a unit of software from the private implementation details. An interface may specify data input and output types, and may imply one or more expected behaviors, but the implementation details can vary widely. Different implementations of an interface can be transparently substituted for each other—or “plugged in”—without disrupting the other pieces of software that rely on the interface. Such implementations in view of the present disclosure are believed to be within the capabilities of those ordinarily skilled. The interface concept may be common to object oriented software design.

In one or more plug-in embodiments, PRISM or design visualization system plug-ins may act as a bridge between a designer and a data center. The plug-in may allow the designer to specify attributes, such as but not limited to, geographical coordinates of a project, add commercial and/or public domain data layers describing the surrounding environment, and specify lighting, materials, fixtures, furniture, and appliances from a database of photo-realistic, physically accurate or other models.

Once a design is uploaded to the data center from this plug-in embodiment and/or a stand alone embodiment, the design visualization system, or a resource manager of the design visualization system, may automatically delegate tasks to compute nodes, local and/or remote, and may in some instances load-balance these tasks according to criteria including but not limited to capabilities and latency of available node resources, network throughput and/or one or more characteristics of a design task. The compute nodes may render different camera views and return their results to the design visualization system and/or resource manager, which may generate one or more requested output types. For example, output could include high resolution still images, such as JPEG, a sequence of images comprising an animation, such as MPEG, a Microsoft PowerPoint or other presentation file, a standalone Adobe Flash or other flash application, an automatically generated web site which may allow dynamic, interactive viewing from a web browser, or the like. However, it should be noted that these are merely example embodiments and claimed subject matter is not intended to be so limited.

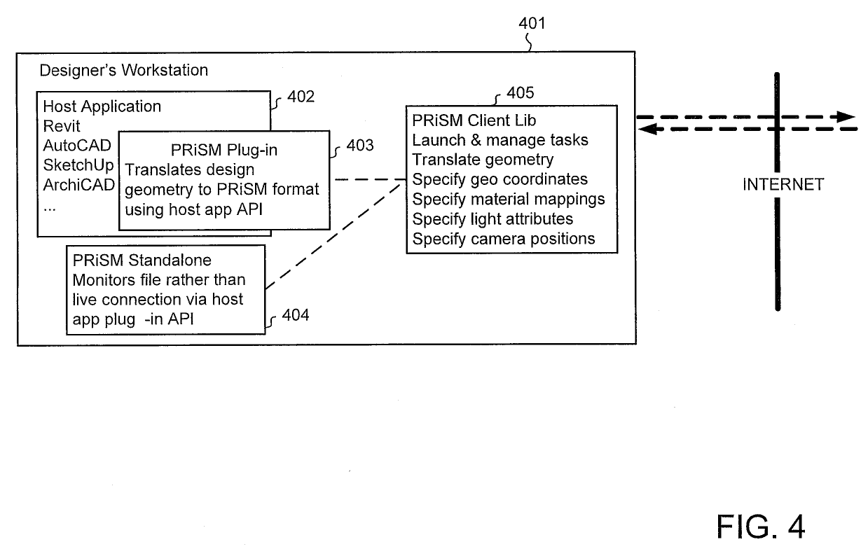

As shown in FIG. 4, for some embodiments the design visualization system client may run as a plug-in within the process of a host application, and may rely on a vendor-provided API to extend the functionality of the host application. However, in other embodiments the design visualization system client may run as a standalone application. In some stand-alone embodiments, the design visualization system, method and/or apparatuses described herein may monitor one or more files in a file system, and upon detecting an update, parse or re-parse the file. Again, these are merely example embodiments and claimed subject matter is not so limited.

FIG. 4 shows an embodiment of a designer's workstation 401. Workstation 401 includes a host application 402. Example host applications may include, but are not limited to, Autodesk AutoCAD, Autodesk Revit, Autodesk Inventor, Graphisoft ArchiCAD, Bentley Systems Microstation, Google SketchUp, Dassault Systemes SolidWorks, Dassault Systemes CATIA and the like. Workstation 401 also includes a PRiSM plug-in 403, which may be associated with host application 402. PRiSM plug-in 403 may translate geometry and/or design parameters from a proprietary or other format of host application 402 into a native format used by PRiSM. In this embodiment, it may accomplish this translation by using the host application 402 API. Designer's workstation 401 also shows standalone PRiSM 404, which in an embodiment, may monitor design files, rather than be connected to host application 402. Designer's workstation 401 also contains library 405, which in this embodiment, may launch and manage tasks, translate geometry, specify design attributes, such as but not limited to geographical coordinates, material attributes, lighting attributes and/or camera positions. Workstation 401 is capable of communicating with design visualization system servers across the internet in this embodiment.

One or more embodiments of the design visualization system may include “one-click render” capabilities. A user may, for example, choose to employ this embodiment during the early stages of the design process, but it may be used at any phase of a design project. At this stage, a designer may not yet be concerned with specifying material and lighting details. For this embodiment, the architectural rendering system may provide a default “look” that may allow the designer to see a visualization representing the current state of her design without having to specify one or many cryptic settings, manually importing and exporting files from desktop applications, or managing a network render farm. Clicking a single button, as descried in this embodiment, may leverage an amount of hardware and software complexity, but all of this complexity may be hidden from the user, who automatically receives one or more renderings based at least in part upon sending a rendering request. Depending upon subscription level, this single click may have harnessed the power of tens or hundreds of computers, for example, to quickly return a highly compute-intensive result.

For a “one-click” embodiment, the user may utilize an industry standard CAD application to create a work-in-progress and invoke a design visualization system plug-in (or stand alone). For some applications, a user may provide account credentials if this is the first access in this session. To employ this embodiment, the user may click on a “render” or other button.

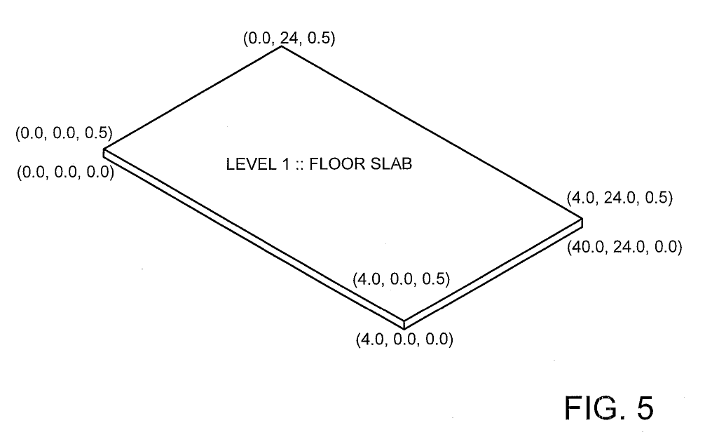

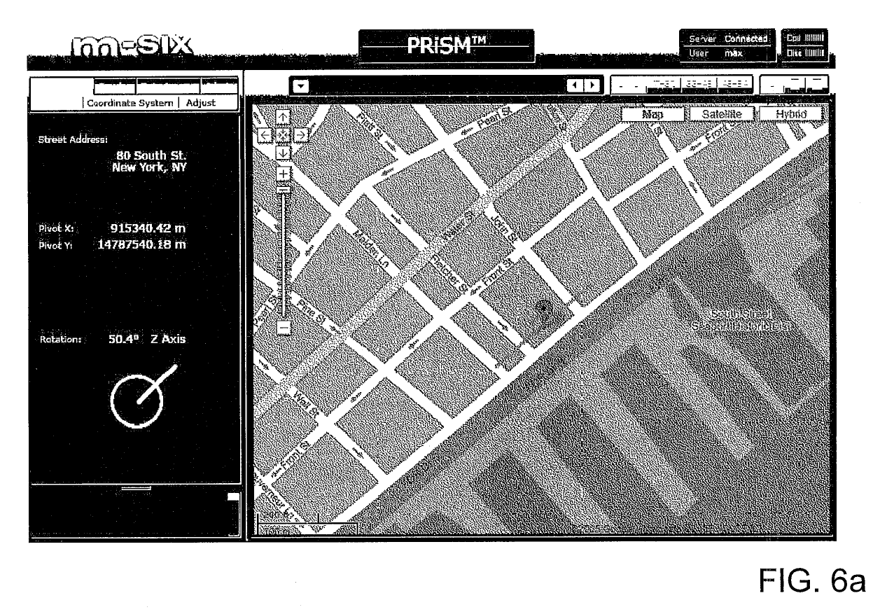

Upon clicking on a “render” button, a plug-in application embodiment may call the architectural visualization system host application API to traverse its scene database, translating one or more objects it encounters. The scene database should not to be confused with a relational database. For example, a scene database may be a tree structure or directed acyclic graph stored in memory or on a flat file in a file system. As an example, the plug-in might encounter a group of objects called “Level 1” and the first object in this group might be called “Floor Slab”. The plug-in may query the host application to determine the physical characteristics of this object, which may be represented with simple polygonal geometry using XYZ Cartesian coordinates in three dimensional space, as illustrated in FIG. 5. The plug-in may continue until it has translated some or all of the objects from the host application into the design visualization system's native scene database format.

One or more embodiments may apply one or more default settings for rendering attributes to create a default “look” for one or more objects in the scene database. For example, a default look might include one or more settings such as: locating the scene at 45.5° North, 122.6° West, rendering all objects as made of white plastic, setting the location of the sun as physically correct for 10:00 am on June 1, setting a virtual camera using a 50 mm lens at f5.6, and so on. The design visualization system may set one or more default settings based at least in part upon context of a design and/or previous attribute selections for a design. The design visualization system's ability to utilize one or more default settings may contribute at least in part to its ability to render designs which may be photo-realistic, in an efficient manner and/or without requiring a user to have specialized visualization rendering skills. (For example, a user may not need to understand how a lighting source type and/or angle might affect appearance of a design at different camera angles, because the design visualization system in some embodiments may set default one or more lighting sources and angles.) In this manner, in some embodiments, the design visualization system may make aesthetically suitable assumptions for default settings. In various embodiments, a user may elect to alter one or more default settings and/or specify attributes instead of or in addition to employing one or more default look settings. Many other default settings are possible and this is merely one example of a particular default look.

In addition, output type may have one or more default types in some embodiments. For example, the output type may default to a single still image at, for example, 1280×720 resolution with 32-bit RGBA pixels in PNG file format. In various embodiments, a user may elect to alter one or more default settings and/or specify attributes instead of or in addition to employing one or more default output settings. Many other output types and default settings are possible, and this is merely one example.

For one or more embodiments, a message may be constructed with the scene database and look as the payload, and this message may be transmitted to the resource manager in the data center. The resource manager may construct a message to the client with the final image as the payload. The plug-in (or stand-alone application) may open a window displaying the rendered image, along with metrics describing the resources used in its creation. Again, this is but one example and claimed subject matter is not intended to be limited to this particular embodiment.

In one or more embodiments, a user may choose to create a design rendering with a one-click render and also publish the rendering to viewing devices in addition to or instead of the designer's workstation. In this case, the user may wish to share the visualization with a wider audience. Rather than displaying the resulting image solely on the designer's workstation, it may displayed on other viewing devices instead of or in addition to the designer's work station, and/or be contained on an automatically generated web page or site hosted by the design visualization system. In some embodiments, the design visualization system may publish the rendering(s) to a web page or site that is not hosted by the design visualization system. In some embodiments, the design visualization system may include one or more data center web servers for publishing renderings. In some embodiments, the design visualization system may publish rendering(s) to a web page or site without requiring manual intervention and/or web development skills.

Among different embodiments with an option for publishing to a web page, one particular embodiment may include a “render & publish” or similar button for a user to click to activate this functionality. Upon receiving a “render and publish” command, the scene database may be traversed as discussed above. A “render request” message may be sent to the design visualization system and/or resource manager with the output type set to web, among other output types if desired. The design visualization system and/or resource manager may process the message as discussed above with one-click render embodiments, with the following additional steps. A HTML/CSS template for this project may be retrieved from the design visualization system and/or storage manager therein and a file system path to the newly rendered image may be inserted into an <img> tag. If this is the first web output for this project, the root website may be created and access permissions may be set, if desired. The URL of the rendered image may be bundled into a message and returned to the user. Thus, one or more viewers concurrently or sequentially can view user visualizations (with permission, if permission access is set) by simply clicking on the returned URL. This embodiment will be understood to have publishing and collaboration aspects. Other embodiments having a publish to a web site or web page option are possible and claimed subject matter is not intended to be limited to this particular example.

In one or more further examples, a user may specify visualization attributes for a design employing the architectural visualization system described herein. This scenario illustrates the ways a designer may specify one or more aesthetic characteristics of a visualization. This may include, for example, specification of materials, finishes, lights, fixtures, and camera parameters. Other specifications and attributes are within the scope of embodiments. Despite this additional user input, workflow automation in the current system and the use of real-world objects and units when specifying attributes, may make the design visualization system described herein more user friendly and efficient than prior rendering tools.

As discussed above, known design methods may require substantial human involvement and design rendering expertise. For example, creating a rendering with three-dimensional properties and displaying some or all of the surface properties that dictate its interaction with light in the scene, generally may require multiple or numerous manual operations to render, as well as rendering expertise. Using the design tool Autodesk Revit as an example, upon export of a model, a user must specify how Revit objects are classified individually. For complex designs, this classification may be time consuming and/or require design expertise. Then, a design generally must be manually imported into a visualization tool, like Autodesk 3D Studio Max, to create a visualization. These classifications may be generally manually mapped to highly technical representations of object surfaces. Thus, a great deal of graphics expertise may be required to create convincing, photo-realistic representations of 3D geometry.

However, the present design visualization system automates rendering tasks and thus may take out manual classifications previously required and also may employ real-world attributes that may by-pass traditional design parameters. For example, instead of having to classify multiple lighting conditions and camera angles manually, which may require user knowledge of lighting conditions for different object surfaces and light sources and/or camera angles, the present design visualization system may, in some embodiments, allow a user to select a type of lighting source (as opposed to having to know one or more specific light measurements for a particular type of lighting source and individually may these lighting conditions) and a specific day and time (as opposed to having to know what the sun angle would be at a particular time of day for a particular day of the year). In this sense, embodiments of the present design visualization system may be user friendly and allow users without design expertise to participate in design visualization.

An example of using “real-world” units that is possible with one or more embodiments, may include specifying a light source as “50 watt halogen” instead of being forced to specify numerous parameters peculiar to a particular rendering algorithm to achieve the same result. This aspect of the design visualization system according to one or more embodiments may be more user friendly and require less manual operations than prior known applications and methods.

An example of using “real-world” objects that is possible with one or more embodiments, may include specifying a Subzero freezer with manufacturer product #601F/S instead of being forced to specify numerous geometrical, lighting, and material parameters peculiar to a particular rendering algorithm to achieve the same result. This aspect of the design visualization system according to one or more embodiments may be more user friendly and require less manual operations than prior known applications and methods.

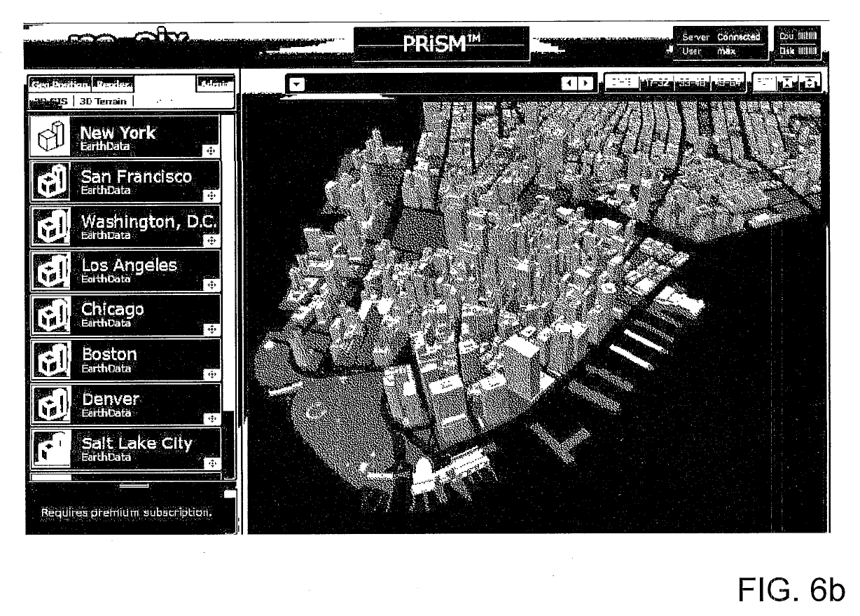

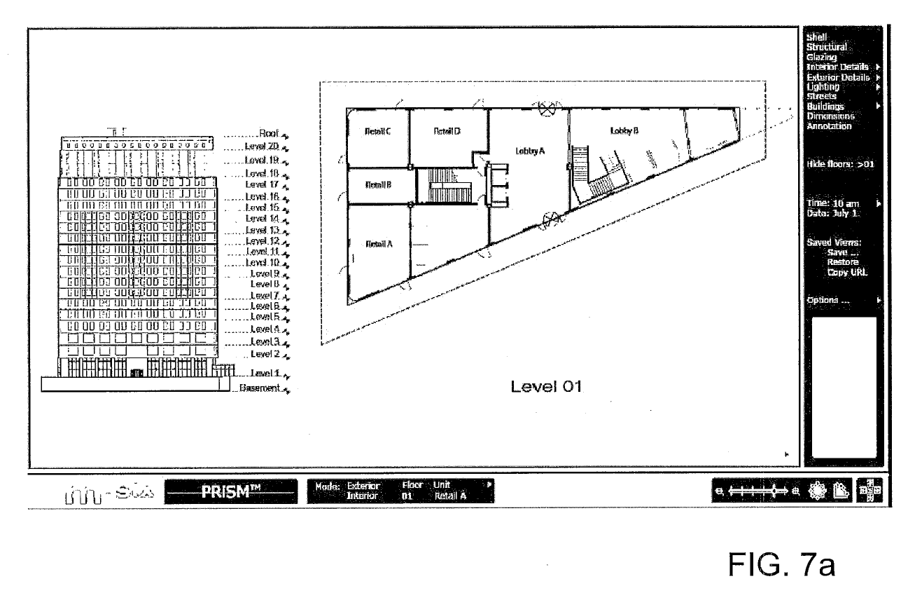

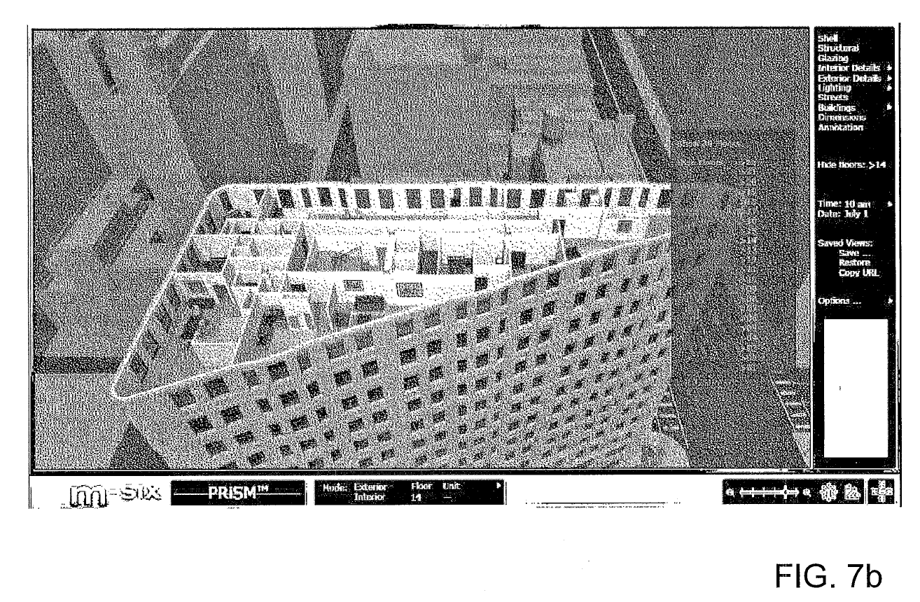

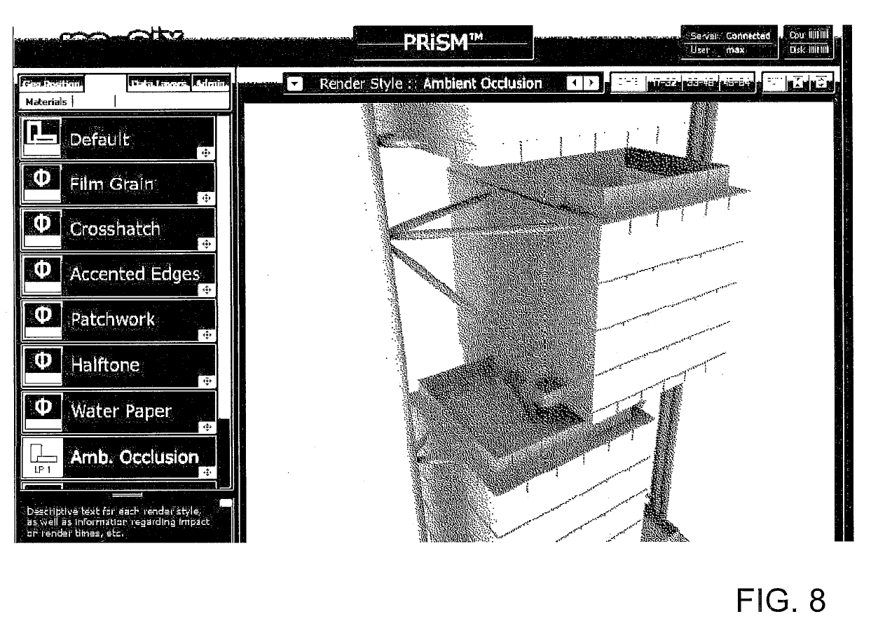

In one or more embodiments having attribute specification capabilities, different design attributes may be specified by a designer. For example, as shown in FIG. 6a, the geographic coordinates of a project may be specified. FIG. 6a shows an example screen shot from one embodiment having capabilities for specifying geographical coordinates, showing a mapping of the geographical coordinates. Once the real-world geographical coordinates are specified, in some embodiments, the system may know where the project is located, and act as a kind of data curator, offering commercial and public domain data describing the surrounding environment. For example, FIG. 6b shows a selection of city models corresponding to the latitude and longitude coordinates specified in FIG. 6a. In some embodiments, the design visualization system may offer a list of objects as described by the host application, and a visual preview of the default material and lighting mappings. The designer may then override or customize any of these or other default mappings. FIG. 7a shows an example of a building floor plan rendered with a two-dimensional specification. FIG. 7b shows an example of the building in FIG. 7a that has instead been rendered with a three-dimensional specification. As shown in FIG. 8, if a non-photo-realistic approach is desired, the designer may select from a one or a number of stylized options in some embodiments. FIG. 8 shows an example of a stylized rendering in accordance with an embodiment. In various embodiments allowing a designer to specify attributes, the designer may specify physically correct camera and lens properties to render a photo realistic visualization. The designer may specify the date and time for a physically correct location of the sun. The designer may specify output type and launch the job, as in other embodiments described above.

Another aspect of one or more design visualization system embodiments described herein is distributed processing. One or more embodiments may employ distributed processing for both design input and model viewing.

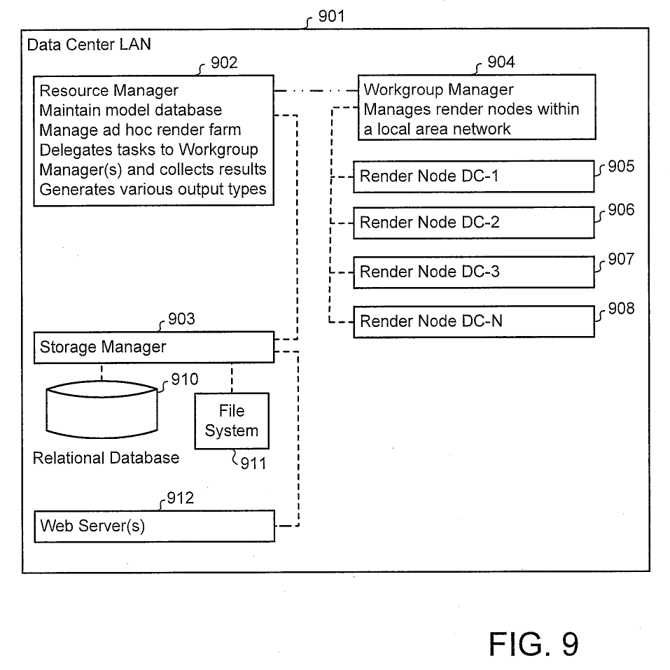

One or more embodiments may include a data center. For example, FIG. 9 shows data center 901 including resource manager 902, storage manager 903, workgroup manager 904, and render nodes 905-908. These software or other entities may run on conventional enterprise server hardware and may be connected by a Local Area Network (LAN) using, for example, the previously described messaging bus. Those of skill in the art will appreciate that these functions may be differently parsed, distributed or combined, within the spirit and scope of the invention. For example, certain or all functions of resource manager 902, storage manager 903 and workgroup manager 904 could be separated or combined within the functional domain of the data center 901 LAN or otherwise. Those of skill in the art also will appreciate that one or more of these blocks, e.g. workgroup manager 904, and its inherent functions can be replicated, as will be discussed below.

Resource manager 902 may coordinate the activities of some or all of the other design visualization system subsystems. Its responsibilities may include, but are not limited to: communications with one or more PRISM clients running on customer machines; persisting customer data to one or more relational databases and/or flat or other file storage via storage manager 903; and/or checking permissions and/or entitlements. For example, resource manager 902 may determine the number of render nodes 905-908 to assign to a particular task based on the customer's subscription level. Resource manager 902 may also delegate tasks to one or more workgroup managers 904. (The embodiment shown in FIG. 9 shows only one workgroup manager 904, but employing multiple workgroup managers 904 in geographically remote data centers is possible in different embodiments.) Resource manager 902 may also collect results from workgroup manager(s) 904, and/or generate final output. Output types may include, for example, high resolution still images, a sequence of images comprising an animation, a Microsoft PowerPoint file, a standalone Adobe Flash application, or an automatically generated web site allowing dynamic, interactive viewing from any web browser. Again, FIG. 9 only depicts one possible embodiment and claimed subject matter is not intended to be limited to this particular embodiment.

Storage manager 903 may manage relational database 910 and/or file system 911. As discussed above, relational database 910 may contain rendering attributes, such as, but not limited to, material attributes, lighting attributes, camera angles, camera range of motion and/or geographical coordinates. Data center 901 may also contain one or more web servers 912. In some embodiments, web servers 912 may be capable of hosting one or more web sites or pages for viewing renderings. Work group manager 904 may manage nodes 905-908 via a LAN or other coupling.

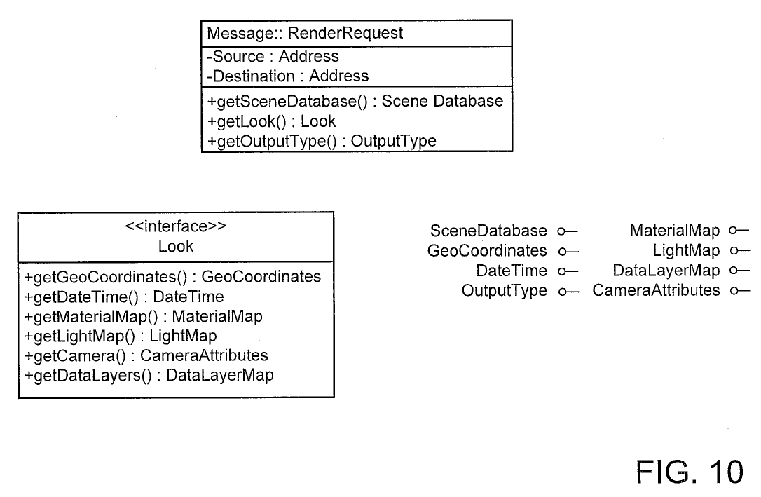

Various embodiments may be used to render a single image output. This scenario may be triggered by a “RenderRequest” or similar message, which may have the example structure shown in FIG. 10. In this example, resource manager 902 may receive and parse a “RenderRequest” message. The scene database may be examined. If the rendering request is an incremental change, then this “RenderRequest” message may contain only the changes since the last message was received for this user and project. It may be reconciled with the previously stored scene database to ascertain incremental edits. For large and/or complex projects, for example, this may reduce the amount of data that must be transmitted over the network. It also may reduce the time, cost and computational overhead of re-rendering a scene based thereon. Among other instances, this may be used for nominal still image changes or nominal moving image changes (e.g. animations or object rotations).

The “Look” data structure, shown in FIG. 10, may be persisted to storage manager 903. Specifying all of the choices encapsulated by the “Look” can represent an investment of time and creativity. By maintaining a history of these choices, the system can save the user time in future sessions.

In some embodiments, the render job may be divided into sub-tasks for each workgroup manager 904. A “WorkgroupRenderRequest” message may be constructed and sent to one or each workgroup manager 904. This message may be similar to a “RenderRequest,” with the addition of sub-task details. In the case of a single image, the sub-task may describe which tile of the overall image frame to render. For example, if the image frame is 100×100 pixels, the sub-task might specify rendering [20, 50] to [29, 59]. Again, this is merely one example and many other messaging possibilities exist within the scope of embodiments.

In one or more embodiments, workgroup manager 904 may parse an assigned sub-task into multiple sub-sub-tasks assignable to one or plural compute nodes 905-908, as illustrated. Data enter 901 may employ multi-level nested resource allocation of rendering among plural nodes 905-908. Nodes 905-908 may be remote from one another and/or may be remote from the designer. Basically, by employing this design visualization system with remote delegation capabilities, the location of nodes 905-908 as compared to the designer, is irrelevant A (so-called “parallel”) or pipelined topology for the typically computationally rigorous rendering task(s) thus may be achieved.

In one or more embodiments, resource manager 902 may receive and/or process “RenderResult” messages from workgroup manager 904. These intermediate results may be stored in relational database 910 via storage manager 903.

Once results for a project are received from work group manager 904, the final output may be generated. In some embodiments, if a single image is being generated, resource manager may simply collect the pixel values from storage manager 903 and translate the raw pixels into one or more requested output file formats. The final image may be bundled in a message and sent to the source address of the “RenderRequest” message (to the designer's terminal).

Sometimes more than one workgroup manager 903 may be used in an embodiment. This scenario may leverage the power of abstracting computing resources with a plug-in interface, and connecting these resources with a generic messaging system. For example, PRiSM may dynamically create a pool of computing resources, and load balance between them based on real-time metrics of throughput and latency. Again, this is merely one example and claimed subject matter is not intended to be limited to this particular embodiment.

For example, messages between resource manager 902 and a workgroup manager 904 may provide a sample of network latency, and “RenderResult” messages may provide a sample of computational throughput. These samples may be stored in relational database 910. In some embodiments, if resource manager 902 delegates a unit of work, it favors low latency, and high throughput resources. This can result in a performance benefit, from monitoring network latency to manage network traffic. For example, a latency threshold may be set that disqualifies a particular workgroup manager 904 from accepting tasks requiring large transfers of data, or that changes the granularity of messaging to be less “chatty” and work on larger tasks thereby reducing messaging overhead. Consequently, the system may harness the power of grid computing or utility computing, which is a business model whereby computing resources may be provided on an on-demand and pay-per-use basis. Examples include Sun Grid, HP's Utility Data Center, Amazon EC2, and others. The system may also harness general purpose computing on graphics processing units. As PC graphics hardware increases in power and flexibility, GPGPU is a trend in computer science that uses the Graphics Processing Unit to perform computations instead of, or in addition to, the CPU. GPUs may be particularly adept at the parallel floating point calculations common to photo-realistic light modeling algorithms. The system may also harness ad hoc peer-to-peer networks to dynamically change the available computing resources. In this context, an “ad hoc peer-to-peer network” may describe the case in which computing resources located on a customer's Local Area Network are made available to PRiSM's resource manager. This may allow the designer's workstation, and any other customer computers, to contribute computing power to the overall rendering effort.

Accordingly, those of skill will appreciate that various embodiments may be implemented in software, firmware, hardware, or any suitable combination thereof. For example, graphics hardware alone or graphics hardware-accelerated software or firmware could perform high-speed moving image rotation or step-wise rotation via interpolation between angled, e.g. 6.0675°, steps, thereby taking advantage of the human viewer's somewhat forgiving visual persistence. Further, the plug-in interface design enables future computing resources with unanticipated characteristics to be transparently added to the pool of resources by simply implementing a new workgroup manager plug-in. This is different from a current general approach to network render farms, which may assume the computing resources are relatively homogenous and located on the same LAN. PRiSM's workgroup manager construct may provide a kind of “render farm of render farms”. This generic treatment of computing resources, and the logic to tune its performance in real-time, will be understood to be possible with various embodiments.

In the following example, three workgroup managers, each managing one or more compute nodes, cooperate to combine the computing resources of the PRiSM data center, the customer's computers, and/or an on-demand utility computing grid. It should be noted that any number of workgroup managers can be dynamically detected and utilized so that, for example, the resource manager might distribute work among 20 computers in the PRiSM data center, 8 at the customer site, 50 at Vendor A's utility grid, 100 at Vendor B's utility grid, and so on. Again, this is merely one example and claimed subject matter is not so limited.

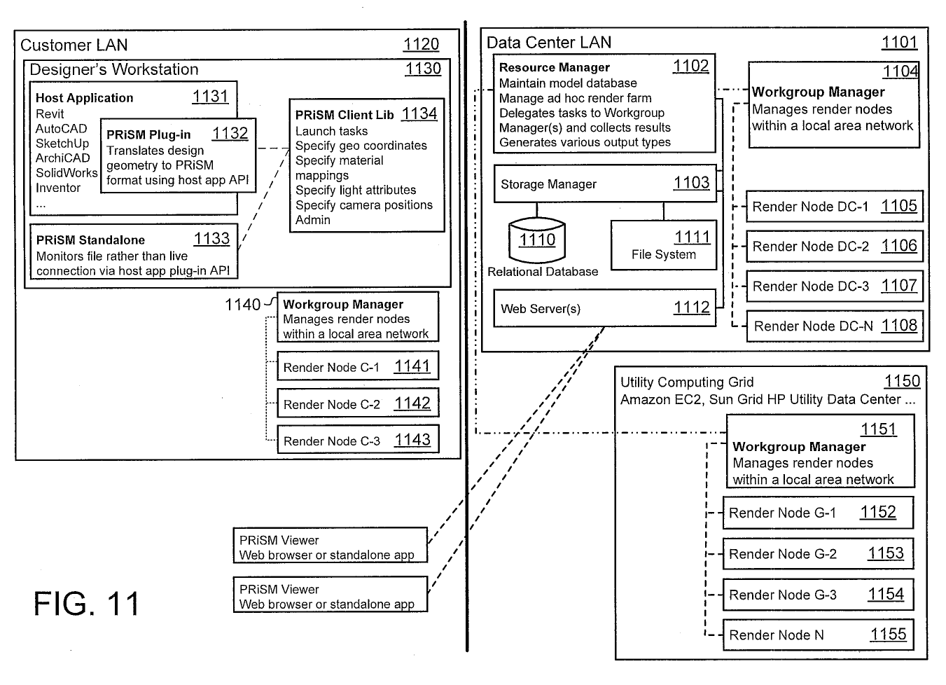

FIG. 11 shows an embodiment of a design visualization system with multiple work groups. FIG. 11 depicts data center 1101. Data center 1101 includes resource manager 1102, storage manager 1103, and work group manager 1104. Work group manager 1104 manages nodes 1105-1108. Storage manager 1103 manages relational database 1110 and file storage 1111. Data center 1101 may include one or more web servers 1112. FIG. 11 shows customer LAN 1120. LAN 1120 includes designer's workstation 1130 and workgroup manager 1140. Similar to the work station depicted in FIG. 4, Designer's workstation 1130 comprises host application 1131, PRiSM plug-in 1132, PRiSM stand alone 1133 and library 1134. Workgroup manager 1140 manages nodes 1141-1143. Workgroup manager 1140 may manage nodes 1141-1143 via a LAN, for example. In some embodiments, the components of workstation 1130 may function in substantially the manner as described for FIG. 4. FIG. 11 also shows utility computing grid 1150. Utility computing grid 1150 includes workgroup manager 1151, which manages nodes 1152-1155. Workgroup manager 1151 may manage nodes 1152-1155 via a LAN, for example. Data center 1101 may be remotely coupled to workstation 1130 and/or utility computing grid 1150 via a wide area network and/or the internet, for example. As such, FIG. 11 depicts an example embodiment that may be used for distributed processing of renderings on nodes 1105-1108, 1141-1143 and 1152-1155.

In this embodiment, resource manager 1102 may retrieve a list of available workgroup managers 1104, 1140, 1151 ready to accept sub-tasks, along with their recent samples of latency and throughput. Resource manager 1102 may examine the characteristics of the next sub-task in the queue. If the sub-task does not depend on the transfer of a threshold amount of supporting data, resource manager may delegate this sub-task to the next available workgroup manager 1104, 1140, 1151 with the highest throughput. The threshold may be configurable and tuned in real-time while the system is running in some embodiments. Supporting data may be any kind of data a rendering algorithm uses to do its work, such as but not limited to, geometrical descriptions of objects, 2D image files used as textures that are wrapped around 3D objects, attributes of lights, cached values of compute-intensive intermediate results, and the like. A pathological example, in terms of sensitivity to network latency, might be a high resolution satellite image that is being texture mapped to a polygon representing the ground. This file might be hundreds of megabytes in size, and could saturate a low speed network connection.

If a sub-task depends on a large data transfer, resource manager 1102 may prefer low latency over high throughput, favoring the workgroup manager “nearest” the large data file. In some embodiments, workgroup managers 1103, 1140, 1151 may cache certain kinds of data for the respective local compute nodes 1105-1108, 1141-1143 and 1152-1155 that each manages. Resource manager 1102 may also track affinity between workgroup managers 1104, 1140, 1151 and large data assets. With this information, resource manager 1102 may elect to place a sub-task on a particular workgroup manager's 1104, 1140, 1151 dedicated queue if it is not immediately available, but it is the best candidate based on latency, throughput, and cached data. These are but a few examples of embodiments within the scope of claimed subject matter.

Various embodiments may produce one or more different output types. Single image output, such as JPEG, has already been discussed. Another type of output is animation, which may be output from the system to a codec such as Windows Media, Flash Video, Quicktime, H.264, and so on, for example, for playback in standard media players. A further example type of output is flash. For example, still images and animations can be packaged for delivery by Adobe Flash. This may be convenient because Flash may be commonly installed on computers and other devices. It may also be a useful format for interactive visualizations installed in kiosks for informational or sales & marketing purposes. A further example type of output is presentation files, such as Microsoft PowerPoint. For standalone presentations, PRiSM visualizations may be automatically packaged as PowerPoint presentations. Interactivity can be simulated by ordering the images according to a specified camera path. A further example output type is a webpage or website. As discussed above, a URL may be sent to potential viewers who could use web-based viewing. A further output type possible is interactive web output, which will be discussed below. Of course, these are merely examples of output types and claimed subject matter is not so limited.

In some embodiments, rendered visualizations may also be explored with interactivity and collaboration features, such as with Adobe Flash and interactive web output types, for example. With currently known visualization tools, generally there exists a tradeoff between interactivity and visual quality. High visual quality can be achieved at the cost of render times measured in tens of hours, and no interactivity. Or tools, such as Google Earth, provide interactivity, but disappointing visual quality. One or more PRISM embodiments may provide both visual quality and interactivity, and collaboration features as well. By harnessing the power of one, two or many compute nodes, the resource manager may in some instances create quality imagery in a relatively small amount of time.

In addition, to provide real-time responsiveness, the caching, compositing, and viewer features described below may provide interactivity and relatively arbitrary piloting of a virtual camera. For example, some embodiments may pre-render camera perspectives and store them with the storage manager. They may be keyed by camera position, rotation, focal length, active data layers, and/or environmental conditions. There may be thousands of pre-renderings stored in the data center, for example. Second, in some circumstances the system may provide a first best visual quality achievable within latency constraints, and then gradually increases the quality over time, if the virtual camera lingers on a particular perspective.

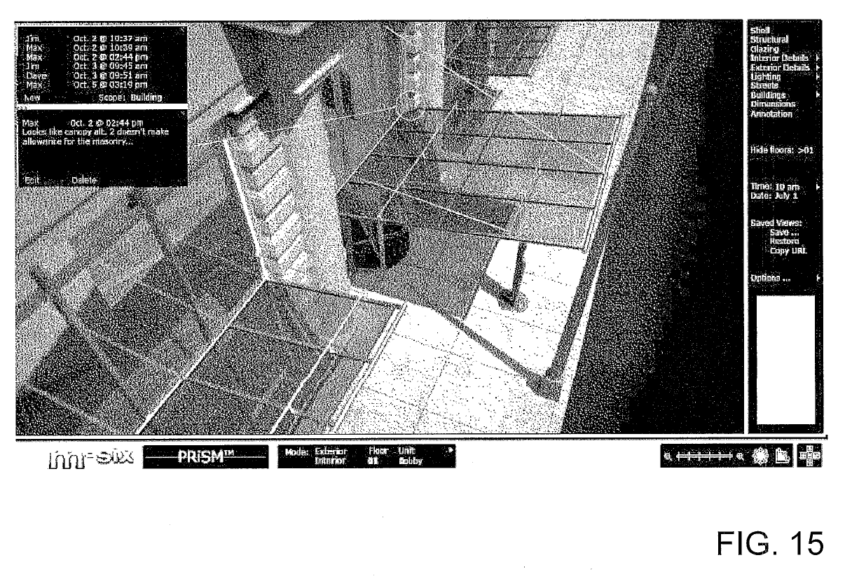

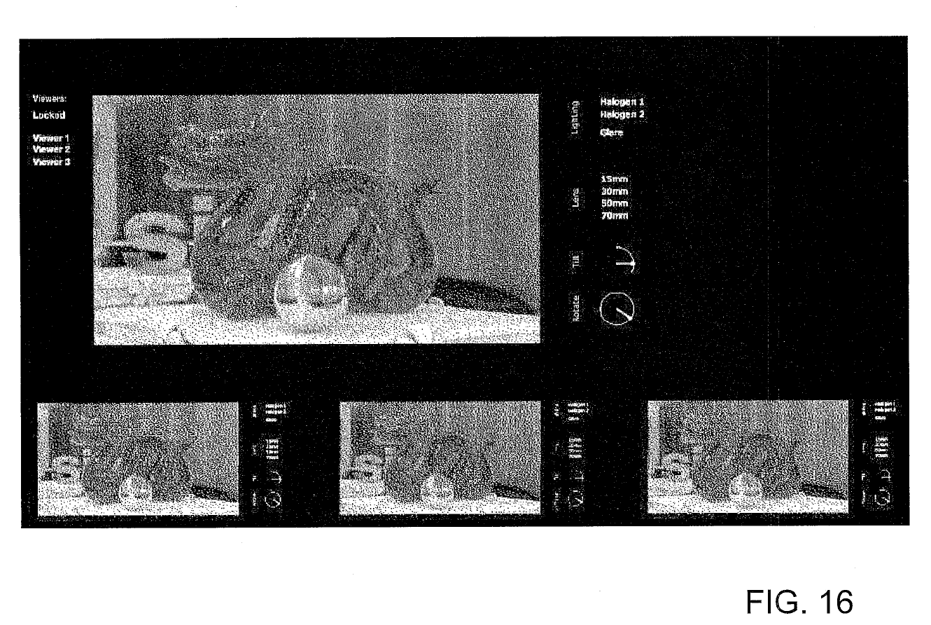

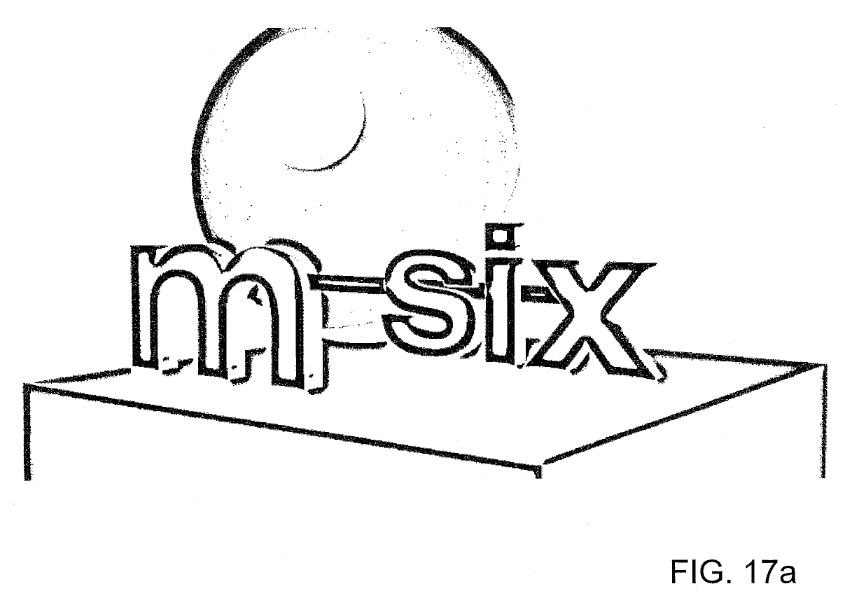

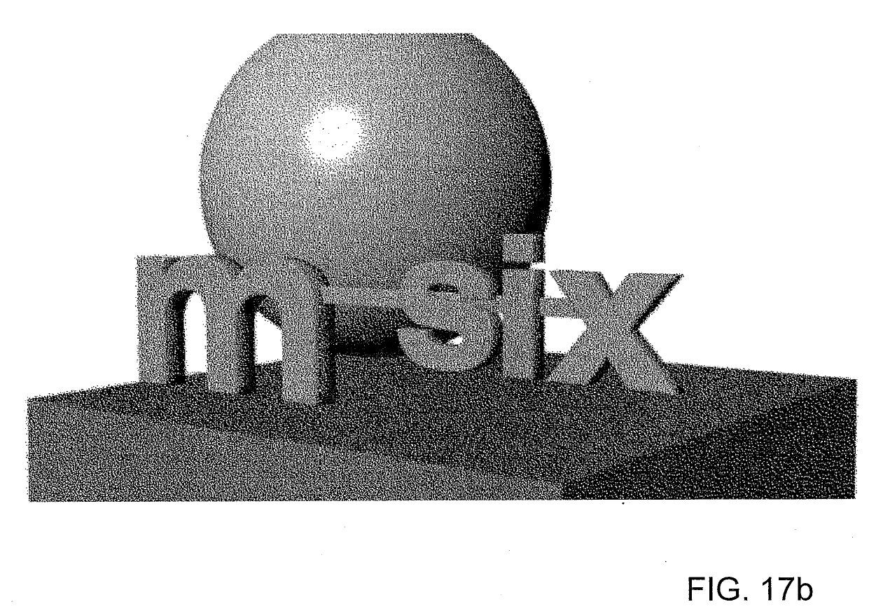

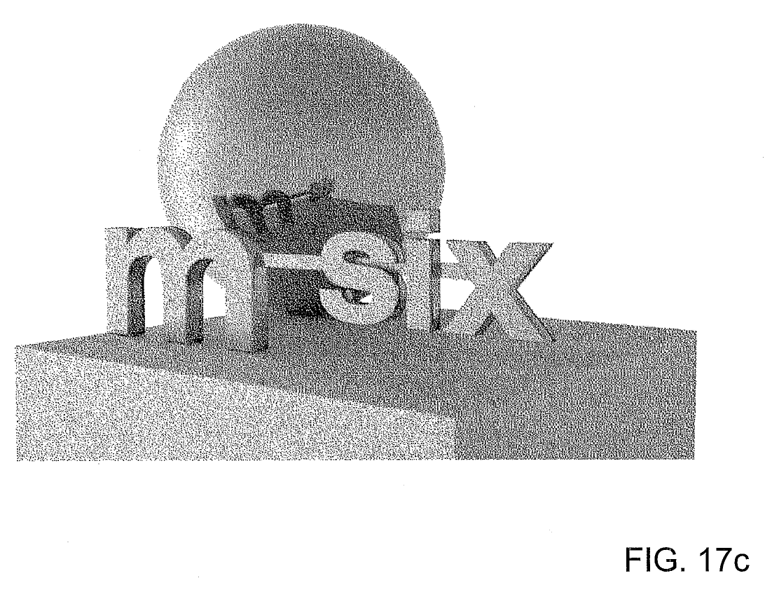

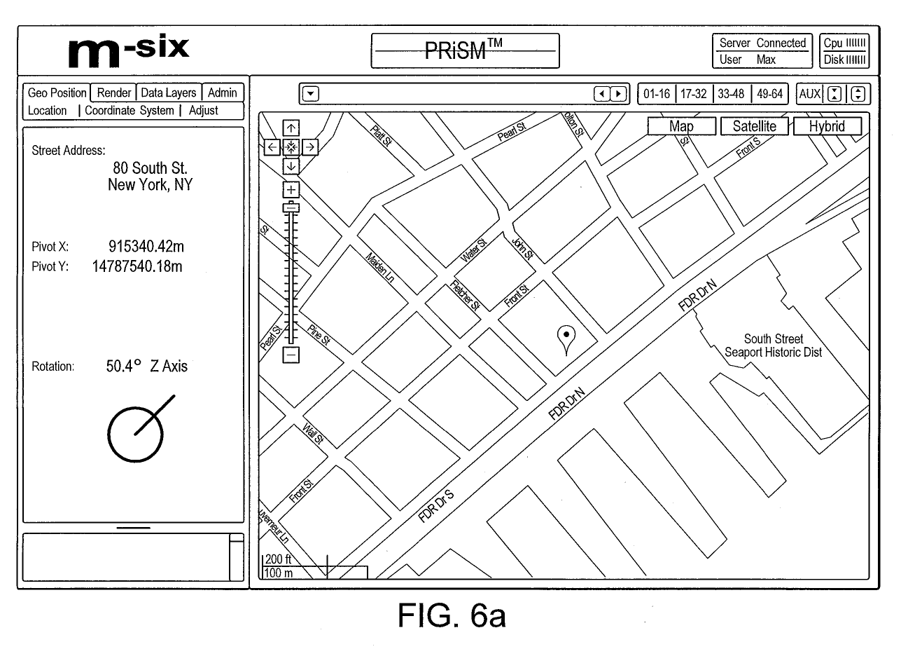

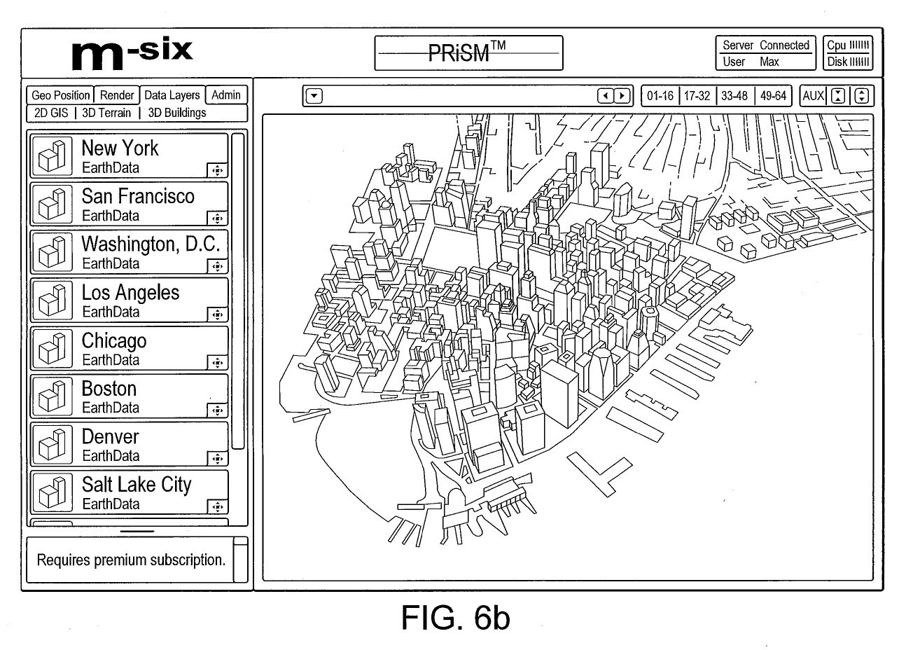

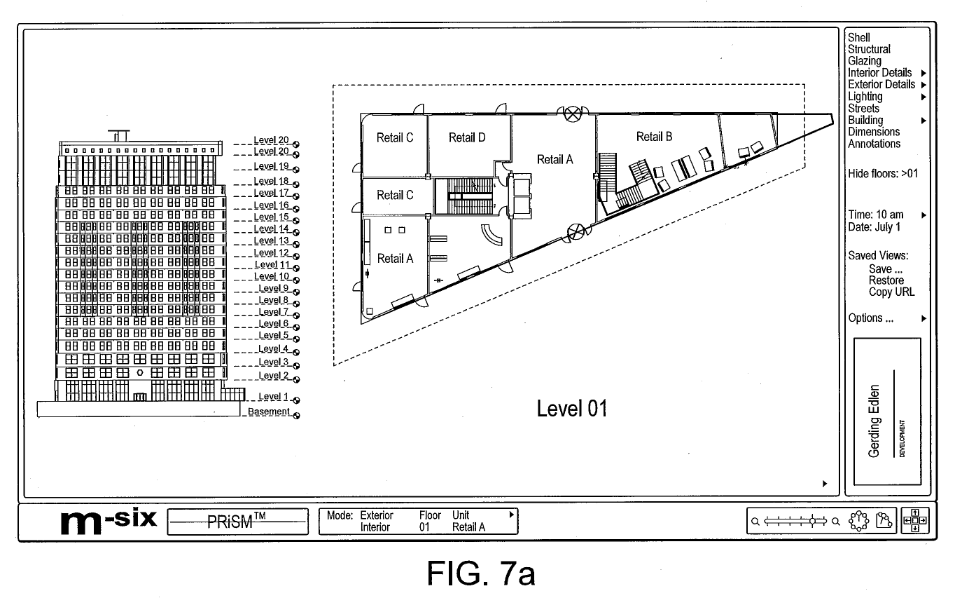

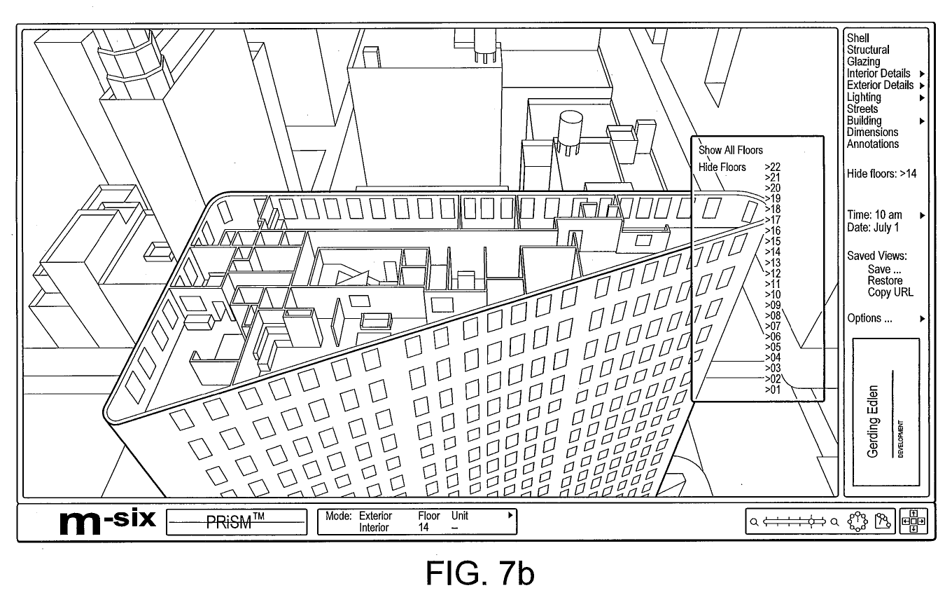

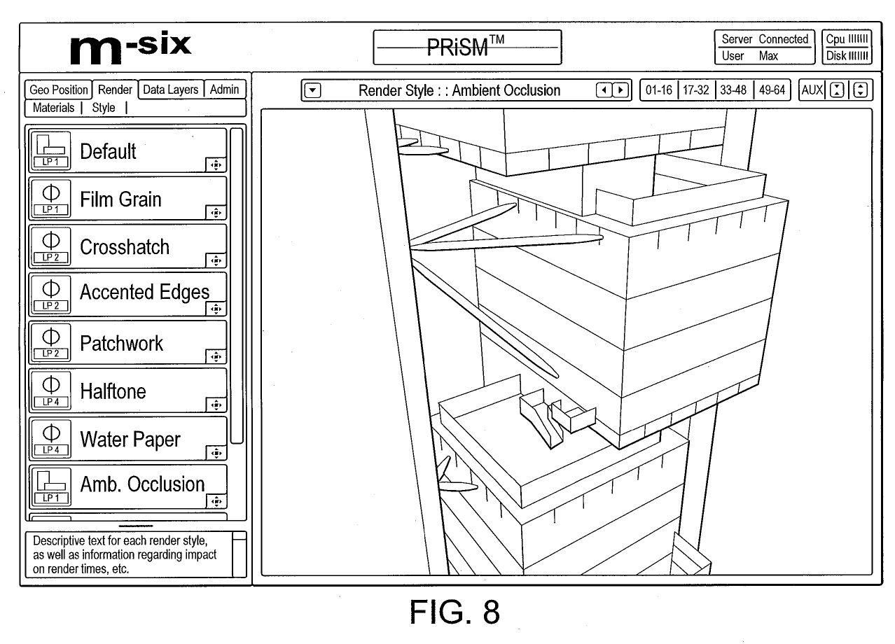

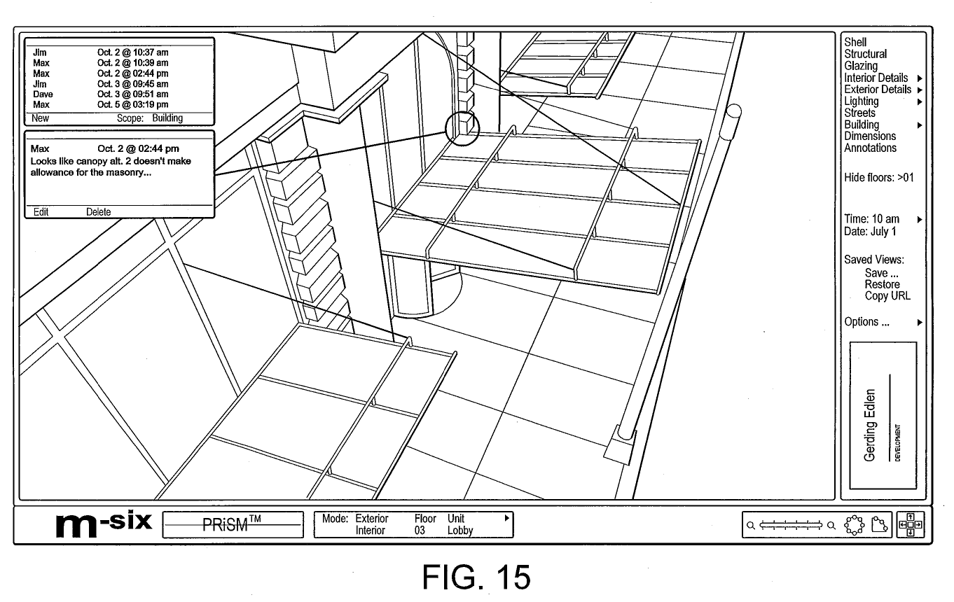

The automatically generated project web sites created by PRiSM may offer collaboration capabilities that can be used by users working at different times and/or geographically remote locations from each other. For situations, such as if collaborators are not working concurrently, annotation tools may allow a user to point out an object in a visualization and enter text comments that are displayed in an optional annotation overlay. FIG. 15 depicts an example of a visualization with annotations added. Annotations may be stored in a relational database via the storage manager, and may be queried by user, location, time entered, comment text, and so on, in some embodiments.

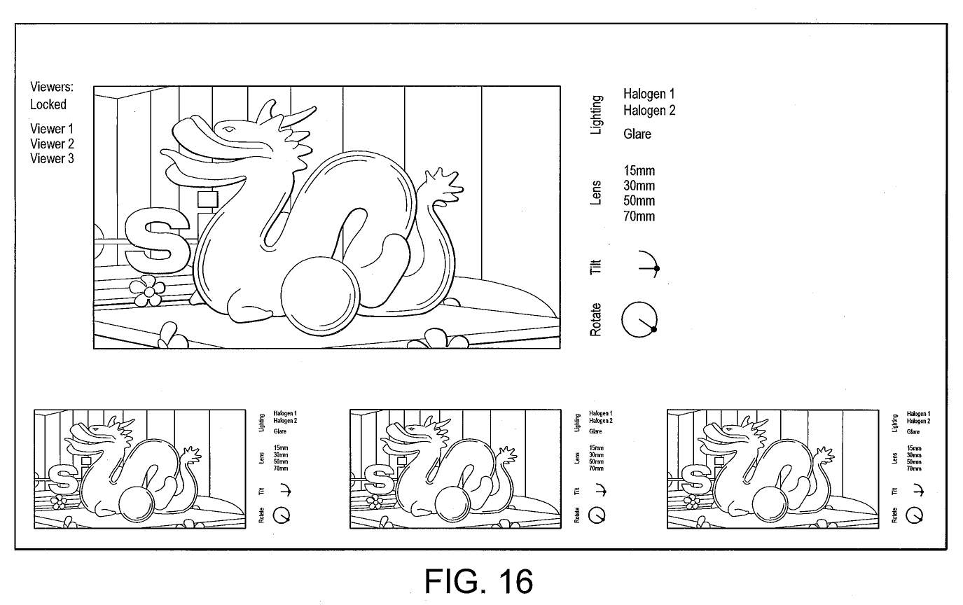

For concurrent collaboration in geographically remote locations, a user designated as the presenter may explore an interactive model and provide commentary while an arbitrary number of viewers see the same imagery on their screens as does the presenter. FIG. 16 shows a screen shot from a concurrent viewing embodiment wherein a presenter may pilot a virtual camera and one or more viewers may see the presenter's camera perspective and data layers. In various embodiments, different individual viewers may be freed to explore the model on their own, and/or take over the presenter role, at the presenter's discretion.

For interactive web viewing applications, some or all imagery may be created ahead of time in some embodiments. For example, with an embodiment having a PRiSM plug-in, a user may employ the plug-in to submit a render request with the interactive web output type. The designer may accept a default range of motion for the virtual camera, or she may provide motion and rotation constraints. For example, rotation on an axis might be constrained to every 11.25° to reduce the render burden, or it might be as fine-grained as every 1° for nearly fluid motion. Once this request is submitted to the resource manager, it may use the available resources to render and cache specified camera, lighting, and layer combinations.

With one or more embodiments, a viewer interested in exploring a model may receive a URL and optional credentials. Using a standard web browser, this user may load the web page corresponding to the URL, and log in if credentials are required. The user may be presented with a user interface, such as one that controls a virtual camera. The camera may be panned, tilted, and rotated. In addition, there may be controls that allow various data layers to be shown or hidden. There may also be controls for the time of day, and the ability to enable or disable certain lights, in some embodiments. The user may click the rotate control. These are merely examples of some display controls and claimed subject matter is not intended to be limited to these particular examples.

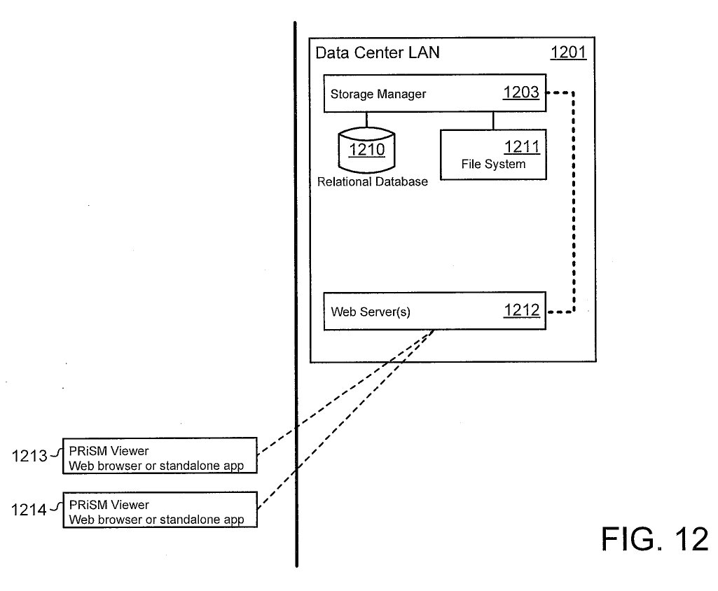

FIG. 12 shows one embodiment of a design visualization system with interactive viewing. FIG. 12 shows data center 1201 including storage manager 1203, controlling relational database 1210 and file system 1211. Data center 1201 includes one or more web servers 1212. Web servers may communicate with viewing devices 1213 and/or 1214 via the internet, for example. Viewing devices 1213 and/or 1214 may be stand alone applications or may be web browsers. Viewing devices may be PCs, PDAs, cellular phones, personal video devices, etc., for example, as discussed above. This is but one example and claimed subject is not intended to be limited to this particular embodiment.

In an embodiment, the PRiSM viewer software may construct a message encapsulating a change in camera position and send this message to resource manager 1202. Resource manager 1202 may receive the message and check storage manager 1203 for a cached render corresponding to the camera, layer, and lighting conditions described in the message. Storage manager 1203 may locate a suitable cached render and return it to resource manager 1202. Resource manager 1202 may scale the image to the requested resolution and return it to the PRiSM viewer software in a “RenderImageMessage,” or similar message. The PRiSM viewer software may receive the message and display the image on the screen. It should be noted that other embodiments may not employ particular viewer software for viewing visualizations created by the design visualization systems of this application. Of course, this is merely one particular embodiment and claimed subject matter is not intended to be so limited.

In another interactive embodiment, real-time rendering may be possible. In this scenario, both cached images and real-time rendered images may be used. A user interested in exploring a model may receive a URL and optional credentials. Using a standard web browser, this user may load the web page corresponding to the URL, and logs in, if credentials are employed. The user may be presented with a user interface that controls a virtual camera. The camera may be panned, tilted, and rotated. In addition, in this embodiment there may be controls that allow various data layers to be shown or hidden. There may also be controls for the time of day, and the ability to enable or disable certain lights. The user may click the rotate control. These are merely a few examples of different embodiments of viewer controls. Claimed subject matter is not intended to be limited to these particular examples.

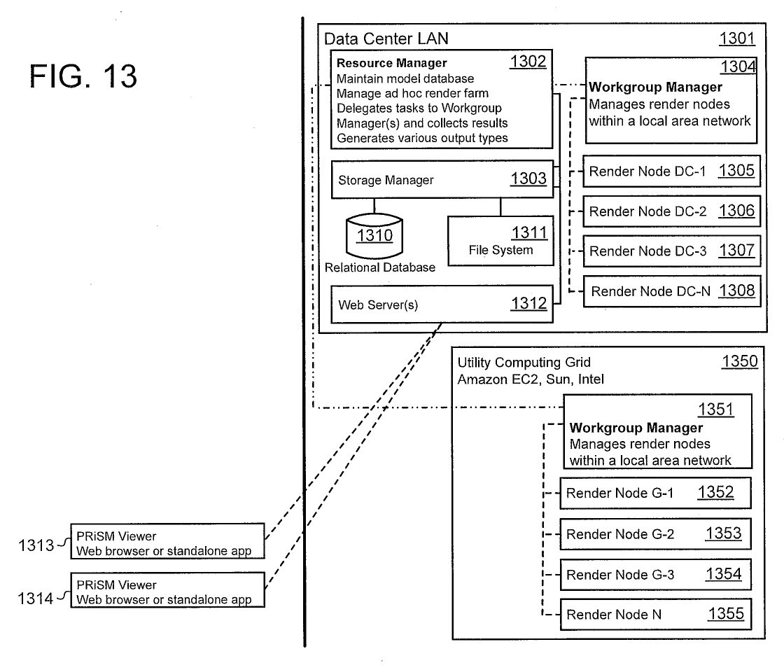

FIG. 13 shows an embodiment of a design visualization system with multiple work groups that may be used for interactive viewing and real-time rendering. This is merely one example of a system that may be used in this manner and claimed subject matter is not so limited. FIG. 13 depicts data center 1301. Data center 1301 includes resource manager 1302, storage manager 1303, and work group manager 1304. Work group manager 1304 manages compute nodes 1305-1308. Storage manager 1303 manages relational database 1310 and file storage 1311. Data center 1301 includes one or more web servers 1312. Web servers 1312 may communicate with viewing devices 1313 and/or 1314 via the internet. Viewing devices 1313 and/or 1314 may be stand alone applications or may be web browsers. Viewing devices may be PCs, PDAs, cellular phones, personal video devices, etc., for example, as discussed above.

FIG. 13 also shows utility computing grid 1350. Utility computing grid 1350 includes workgroup manager 1351, which manages nodes 1352-1355. Workgroup manager 1351 may manage nodes 1352-1355 via a LAN, for example. Data center 1301 may be remotely coupled to utility computing grid 1350 via the internet, for example.

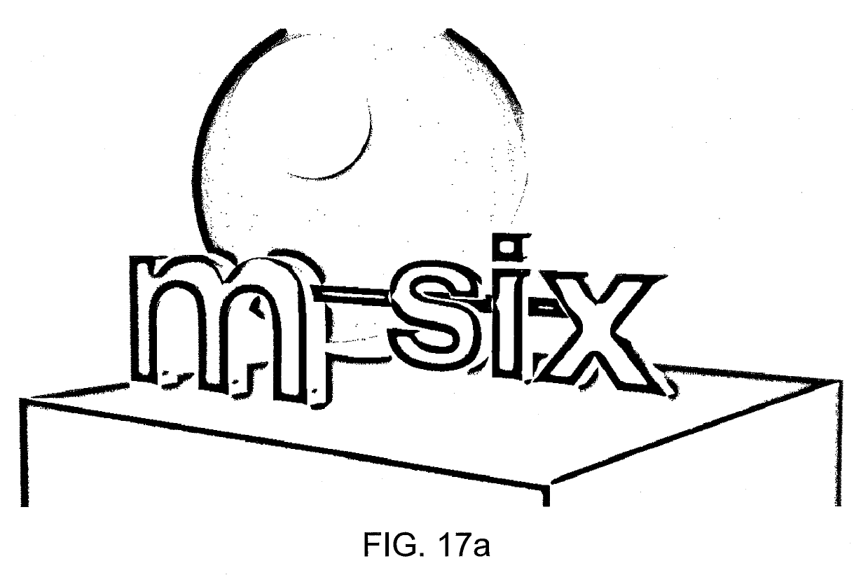

In an embodiment, the PRISM viewer software may construct a message encapsulating a change in camera position and send this message to resource manager 1302. Resource manager 1302 may receive the message and check storage manager 1303 for a cached render corresponding to the camera, layer, and lighting conditions described in the message. Storage manager 1303 may notify resource manager 1302 that no suitable cached render can be located. Based on a configurable response time constraint, resource manager 1302 may calculate a maximum visual quality that can be rendered with the resources available. “WorkgroupRenderRequest” messages may be constructed and broadcast to one or more workgroup managers 1304, 1351. For embodiments with multiple workgroup managers, workgroup managers 1304, 1351 may return their results and resource manager 1302 may assemble the lower quality proxy image. Resource manager 1302 may scale the image to the requested resolution and return it to the PRiSM viewer software in a “RenderImageMessage.” The PRiSM viewer software may receive the message and display the image on the screen. In this embodiment, resource manager 1302 may launch a background process to render the same image at full visual quality. Upon completion, it may be cached in storage manager 1303, and broadcast to the viewer if the viewer's camera is still in the same perspective. FIGS. 17a-17c depict example renderings from an embodiment having this real-time rendering capability. FIG. 17a shows a possible initial best-available rendering. FIG. 17b shows a second possible best-available rendering, possibly created while a user's camera has lingered over the scene more time, and FIG. 17c shows a third possible best-available rendering created after more time has passed. The highest visual quality reached may be cached and serve as the starting point for the next user to view this particular camera perspective and data layer set. Again, these are merely examples and claimed subject matter is not so limited.

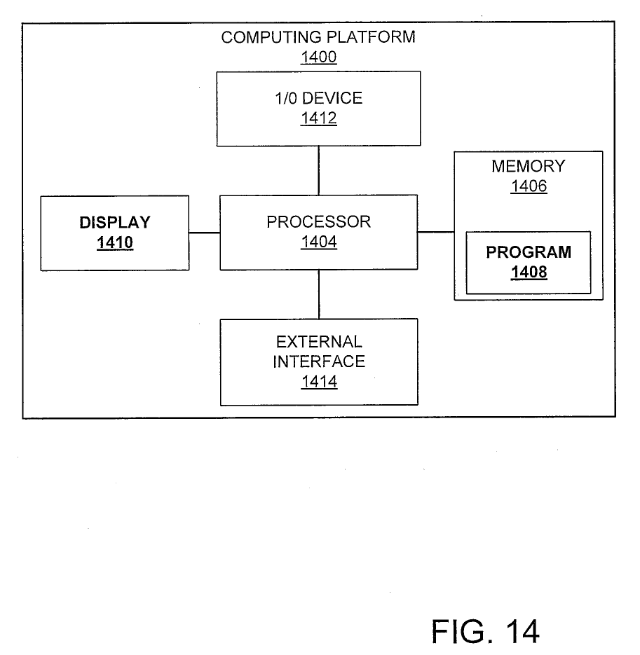

Referring to FIG. 14, a block diagram of an example embodiment of a computing platform 1400 according to one or more embodiments is illustrated, although the scope of claimed subject matter is not limited in this respect. Computing platform 1400 may include more and/or fewer components than those shown in FIG. 14. However, generally conventional components may not be shown, for example, a battery, a bus, and so on.

Computing platform 1400, as shown in FIG. 14 may be utilized to embody tangibly a computer program and/or graphical user interface by providing hardware components on which the computer program and/or graphical user interface may be executed. For example, computing platform 1400 may be utilized to tangibly embody all or a portion of the method of FIG. 2 and/or other procedures and systems disclosed herein. Such a procedure, computer program and/or machine readable instructions may be stored tangibly on a computer and/or machine readable storage medium such as a compact disk (CD), digital versatile disk (DVD), flash memory device, hard disk drive (HDD), and so on. As shown in FIG. 14, computing platform 1400 may be controlled by processor 1404, including one or more auxiliary processors (not shown). Processor 1404 may comprise a central processing unit such as a microprocessor or microcontroller for executing programs, performing data manipulations, and controlling the tasks of computing platform 1400. Auxiliary processors may manage input/output, perform floating point mathematical operations, manage digital signals, perform fast execution of signal processing algorithms, operate as a back-end processor and/or a slave-type processor subordinate to processor 1404, operate as an additional microprocessor and/or controller for dual and/or multiple processor systems, and/or operate as a coprocessor and/or additional processor. Such auxiliary processors may be discrete processors and/or may be arranged in the same package as processor 1404, for example, in a multicore and/or multithreaded processor; however, the scope of the scope of claimed subject matter is not limited in these respects.

Communication with processor 1404 may be implemented via a bus (not shown) for transferring information among the components of computing platform 1400. A bus may include a data channel for facilitating information transfer between storage and other peripheral components of computing platform 1400. A bus further may provide a set of signals utilized for communication with processor 1404, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and so on, although the scope of the scope of claimed subject matter is not limited in this respect.

Other components of computing platform 1400 may include, for example, memory 1406, including one or more auxiliary memories (not shown). Memory 1406 may provide storage of instructions and data for one or more programs 1408 to be executed by processor 1404, such as all or a portion of FIG. 2 and/or other procedures disclosed herein, for example. Memory 1406 may comprise, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 1406 may comprise, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 1406 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 1400 further may include a display 1410. Display 1410 may comprise a video display adapter having components, including, for example, video memory, a buffer, and/or a graphics engine. Such video memory may comprise, for example, video random access memory (VRAM), synchronous graphics random access memory (SGRAM), windows random access memory (WRAM), and/or the like. Display 410 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth. Although claimed subject matter is not intended to be limited to this type of display.

Computing platform 1400 further may include one or more I/O devices 1412. I/O device 1412 may comprise one or more I/O devices 1412 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like.

Computing platform 1400 further may include an external interface 1414. External interface 1414 may comprise one or more controllers and/or adapters to prove interface functions between multiple I/O devices 1412. For example, external interface 1414 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 1412. External interface 1414 for an embodiment may comprise a network controller capable of providing an interface, directly or indirectly, to a network, such as, for example, the internet.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that if executed by a system, such as a computer system, computing platform, or other system, for example, may result in an embodiment of a method in accordance with claimed subject matter being executed, such as one of the embodiments previously described, for example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A system for providing one or more design renderings, comprising:
a design visualization system capable of accepting one or more designs and/or design parameters from a first device; and
one or more remotely coupled compute nodes which are capable of creating one or more design visualizations based at least in part upon said designs and/or design parameters;
wherein said design visualization system is capable of accepting one or more rendering task requests from said first device, automatically delegating one or more rendering tasks to said compute nodes, and outputting said design renderings to said first device.

2. The system of claim 1 wherein said compute nodes are capable of processing said rendering tasks in parallel, and wherein said design visualization system is capable of load balancing said rendering tasks between said compute nodes.

3. The system of claim 1 further comprising one or more compute nodes coupled to said design visualization system by a local computer network.

4. The system of claim 1 wherein said system is capable of assigning a rendering task to multiple said compute nodes.

5. The system of claim 1 wherein said design visualization system further comprises a data center capable of accepting one or more designs and/or design parameters from said first device.

6. The system of claim 1 wherein said design visualization system further comprises a resource manager capable of accepting one or more rendering task requests from said first device, automatically delegating one or more rendering tasks to said compute nodes, and outputting said design renderings to said first device.

7. The system of claim 1 wherein said design visualization system is capable of specifying one or more attributes for said renderings selected from the group comprising: material attributes, associations between CAD or design application model elements and real-world materials, lighting attributes, associations between CAD or design application model elements and real-world light sources, camera positions, camera range of motion, metadata layers or geographical coordinates.

8. The system of claim 1 wherein said design visualization system is capable of automatically translating one or more designs and/or design parameters from a format of a CAD or other design application used to create said design and/or design parameters to a native format of said design visualization system.

9. The system of claim 1 wherein said design visualization system is adapted to plug-in to a CAD or other design application.

10. The system of claim 1 wherein said design visualization system further comprises a library containing at least one or more specifications from the group comprising: material attributes, associations between CAD or design application model elements and real-world materials, lighting attributes, associations between CAD or design application model elements and real-world light sources, camera positions, camera range of motion, metadata layers or geographical coordinates, and wherein said one or compute nodes are capable of creating said renderings based at least in part upon said specifications.

11. The system of claim 7 wherein said design visualization system further comprises default settings for one or more specifications that are based at least in part upon a context of said design and/or past specifications employed for a project.

12. The system of claim 1 wherein said design visualization system is capable of automatically publishing said renderings to one or more web pages.

13. The system of claim 1 wherein said design visualization system is capable of outputting said renderings to one or more viewing devices.

14. The system of claim 9 wherein said viewing device is selected from the group comprising: computer, kiosk, PDA, personal video device or cellular telephone.

15. The system of claim 9 wherein said viewing device is capable of running a web browser.

16. The system of claim 1 further comprising one or more web servers capable of outputting said renderings to one or more viewing devices.

17. The system of claim 1 wherein said design and/or design parameters describe an architectural, engineering or industrial structure selected from the group comprising: an apparatus, furniture, a consumer device, a mechanical part, a room, a building, a neighborhood, a town, or a city.

18. The system of claim 1 wherein said design visualization system is capable of monitoring said design and/or design parameters for one or more updates, processing said updates at least in part by parsing or reparsing said design and/or design parameters if said update is detected, and maintaining substantial synchronization between the design and/or design parameters and renderings.

19. The system of claim 1 wherein said design visualization system is capable of querying a CAD or other design application for said design and/or design parameters.

20. The system of claim 1 wherein said renderings are output in a format selected from the group comprising: still images, a sequence of images comprising an animation, a presentation file, a file format suitable for an interactive media delivery platform, a website, or a website that is capable of allowing interactive viewing.

21. The system of claim 1 wherein said design visualization system further comprises a storage manager capable of storing a relational database and/or one or more files, and wherein said design visualization system is capable of communicating said stored relational database or files to said compute nodes for use in creating said renderings and maintaining substantial synchronization between said design and/or design parameters and said design renderings.

22. The system of claim 1 wherein said design visualization system further comprises one or more workgroup managers capable of managing said compute nodes, wherein a first said workgroup manager is coupled to a first said compute node by a first local computer network and a second said workgroup manager is coupled to a second said compute node by a second local computer network; and wherein said first and second compute nodes are remotely coupled to each other by a wide area network.

23. The system of claim 1 wherein said design visualization system is capable of delegating to said compute nodes and assigning a number of said compute nodes to employ for a project based at least in part upon criteria selected from the group comprising: subscription level of a user; system latency; network throughput, or one or more characteristics of a rendering task.

24. The system of claim 23 wherein said design visualization system is capable of load balancing among said nodes.

25. The system of claim 1 wherein said compute nodes comprise one or more graphics processing units.

26. The system of claim 1 wherein said design visualization system further comprises an annotation tool capable of adding comments to said renderings.

27. The system of claim 1 wherein said design visualization system is capable of outputting renderings to one or more second devices and wherein said design visualization system is capable of accepting edits to said designs and/or design parameters from said second devices.

28. A method of providing one or more design renderings, the method comprising:
receiving one or more designs and/or design parameters from a first device;
receiving one or more rendering requests from said first device;
selecting one or more attributes selected from the group comprising: material attributes, lighting attributes or camera attributes, based at least in part upon context of said design and/or design parameters or one or more past attribute selections received from said first device;
automatically delegating one or more rendering tasks to one or more remotely coupled compute nodes based at least in part upon said rendering requests;
creating one or more design renderings based at least in part upon said design and/or design parameters and said attributes; and
outputting said design renderings to said first device.

29. The method of claim 28 further comprising receiving one or more attribute selections from said first terminal.

30. The method of claim 28 further comprising automatically translating one or more designs and/or design parameters from a proprietary format of a CAD or other design application used to create said design and/or design parameters to a native format.

31. The method of claim 28 further comprising automatically publishing said renderings to one or more web pages.

32. The method of claim 28 further comprising outputting said renderings to one or more viewing devices.

33. The method of claim 28 further comprising monitoring said design and/or design parameters for one or more updates, and processing said updates at least in part by parsing or reparsing said design and/or design parameters if said update is detected.

34. The method of claim 28 wherein said delegating is based at least in part upon criteria selected from the group comprising: subscription level of a user, system latency, network throughput, or one or more characteristics of a rendering task.

35. The method of claim 28 further comprising annotating comments to said renderings.

36. The method of claim 28 further comprising outputting renderings to one or more second devices and accepting edits to said designs and/or design parameters from said second devices.

37. A method of creating one or more design renderings, the method comprising:
sending a design and/or design parameters to a design visualization system;
sending one or more rendering requests to said design visualization system; and
receiving one or more design renderings from said design visualization system, wherein said design visualization system is capable of automatically delegating one or more rendering tasks to one or more remotely coupled compute nodes based at least in part upon said rendering requests, creating one or more design renderings based at least in part upon said design and/or design parameters, and outputting said design renderings to one or more viewing devices.

38. A method of displaying one or more design renderings, the method comprising:
displaying one or more design renderings on one or more viewing terminals; wherein said design renderings are received from a design visualization system capable of receiving a design and/or design parameters from a first device, receiving one or more rendering requests from said first device, automatically delegating one or more rendering tasks to one or more remotely coupled compute nodes based at least in part upon said rendering requests, creating one or more design renderings based at least in part upon said design and/or design parameters, and outputting said design renderings to said viewing devices.

39. An article comprising: a storage medium having stored thereon instructions that, if executed, result in performance of a method of providing one or more design renderings as follows:
receiving at least one design and/or design parameter from a first device;
receiving one or more rendering requests from said first device;
automatically delegating one or more rendering tasks to one or more remotely coupled compute nodes based at least in part upon said rendering requests;
creating one or more design renderings based at least in part upon said design and/or design parameters; and
outputting said design renderings to said first device.

40. The article of claim 39 having further instructions stored thereon that, if executed, result in translating one or more designs and/or design parameters from a proprietary format of a CAD or other design application used to create said design and/or design parameters to a native format.

41. The article of claim 39 having further instructions stored thereon that, if executed, result in publishing said renderings to one or more web pages.

42. The article of claim 39 having further instructions stored thereon that, if executed, result in outputting said renderings to one or more viewing devices.

43. The article of claim 39 having further instructions stored thereon that, if executed, result in monitoring said design and/or design parameters for one or more updates, and processing said updates at least in part by parsing or reparsing said design and/or design parameters if said update is detected.

44. An apparatus comprising a computing platform, said computing platform being adapted to send designs and/or or design parameters to a design visualization system comprising a data center capable of accepting one or more designs and/or design parameters from said computing platform; one or more remotely coupled compute nodes capable of creating one or more design renderings based at least in part upon said designs and/or design parameters; and a resource manager capable of accepting one or more rendering task requests from said computing platform, automatically delegating one or more rendering tasks to said compute nodes, and outputting said design renderings to one or more viewing devices.

45. An apparatus comprising:
a computing platform, said computing platform being adapted to receive and display one or more design renderings received from an design rendering system comprising a data center capable of accepting one or more designs and/or design parameters from a first device; one or more system nodes capable of creating one or more design renderings based at least in part upon said designs and/or design parameters; and a resource manager capable of accepting one or more rendering task requests from said first device, automatically delegating one or more rendering tasks to said nodes, and outputting said design renderings to said computing platform;
wherein said computing platform is capable of specifying one or more display parameters to said design rendering system to control said display.

46. The apparatus of claim 45 wherein said design visualization system further comprises one or more stored images which said design visualization system is capable of employing for displaying said renderings.

47. The apparatus of claim 45 wherein said design visualization system is capable of receiving design edits and/or design parameters from said computing platform.

48. The apparatus of claim 45 wherein said renderings are in a format selected from the group comprising: still images, a sequence of images comprising an animation, a presentation file, a file format suitable for an interactive media delivery platform, a website, or a website that is capable of allowing interactive viewing.

49. A system for providing one or more design renderings, comprising:
a design visualization system capable of distributing rendering tasks to two or more compute nodes that are not within a single local computer network.

50. The system of claim 49 wherein said compute nodes are capable of processing said rendering tasks in parallel, and wherein said design visualization system is capable of load balancing said rendering tasks between said compute nodes.

51. The system of claim 49 further comprising a resource manager capable of automatically delegating rendering tasks.

52. The system of claim 51 wherein said resource manager is capable of automatically delegating rendering tasks to said compute nodes based at least in part upon one or more criteria selected from the group comprising: node latency; network throughput; or one or more characteristics of said rendering tasks.

53. The system of claim 51 wherein said resource manager is capable of assigning a number of said compute nodes to a rendering task and is capable of changing the number of compute nodes assigned to a rendering task.

54. The system of claim 51 wherein at least one said compute node is remotely coupled to said resource manager across the internet.

55. The system of claim 51 wherein said resource manager is capable of accepting designs and/or design parameters from a first device, retrieving said renderings from said compute nodes and outputting said renderings to one or more viewing devices.

56. A method for communicating design renderings comprising:
communicating one or more designs and/or design parameters from a first device to an design visualization system; wherein said design visualization system is capable of creating design renderings based at least in part upon said designs and/or design parameters by automatically delegating one or more design rendering tasks to one or more remotely coupled compute nodes; and
communicating said renderings from said design visualization system to one or more viewing devices.

57. The method of claim 56 wherein a standardized message protocol is employed for said communications.

58. The method of claim 56 further comprising communicating one or more designs and/or design parameters from said design visualization system to one or more compute nodes.

59. The method of claim 56 further comprising communicating said renderings from said one or more compute nodes to said design visualization system.

60. The method of claim 56 further comprising communicating one or more rendering task requests from said first device to said design visualization system.

61. The method of claim 60 further comprising communicating said rendering task requests from said design visualization system to one or more compute nodes.

62. An apparatus comprising:
means for receiving one or more designs and/or design parameters;
means for receiving one or more rendering requests for said designs and/or design parameters;
means for automatically delegating one or more rendering tasks to one or more remotely connected means for creating one or more design renderings; and
means for outputting said design renderings;
wherein said means for automatically delegating is capable of delegating based at least in part upon said rendering requests and wherein said means for creating is capable of creating design renderings based at least in part upon said design and/or design parameters.

63. The apparatus of claim 62 wherein said means for outputting is capable of outputting said design renderings to one or more means for viewing.

64. The apparatus of claim 62 wherein said designs and/or design parameters are capable of being received from a first device.

65. The apparatus of claim 62 further comprising means for editing said renderings based at least in part upon feedback received from one or more means for viewing.

66. The apparatus of claim 62 further comprising means for storing one or more design attributes selected from the group comprising: material attributes, associations between CAD or other design application model elements and real-world materials, lighting attributes, associations between CAD or other design application model elements and real-world light sources, camera angles, camera range of motion or geographical coordinates, and wherein said means for creating design renderings is capable of creating said design renderings based at least in part upon said one or more stored attributes.

67. An apparatus comprising:
a design visualization apparatus capable of accepting one or more designs and/or design parameters from a first device, automatically delegating one or more rendering tasks to one or more remotely coupled compute nodes for creating one or more renderings based at least in part upon said designs and/or design parameters, and outputting said renderings to said first device.

68. The apparatus of claim 67 wherein said design visualization apparatus further comprises a data center capable of accepting one or more designs and/or design parameters from said first device.

69. The apparatus of claim 67 wherein said design visualization apparatus further comprises a resource manager capable of accepting one or more rendering task requests from said first device, automatically delegating one or more rendering tasks to said compute nodes, and outputting said design renderings to said first device.

70. The apparatus of claim 67 wherein said design visualization apparatus is capable of specifying one or more attributes for said renderings selected from the group comprising: material attributes, associations between CAD or other design application model elements and real-world materials, lighting attributes, associations between CAD or other design application model elements and real-world light sources, camera positions, camera range of motion, or geographical coordinates.

71. The apparatus of claim 67 wherein said design visualization apparatus is capable of translating one or more designs and/or design parameters from a proprietary format of a CAD or other design application used to create said design and/or design parameters to a native format of said design visualization system.

72. The apparatus of claim 67 wherein said design visualization apparatus is adapted to plug-in to a CAD or other design application.

73. The apparatus of claim 67 wherein said design visualization apparatus further comprises a library containing at least one or more specifications from the group comprising: material attributes; associations between CAD or other design application model elements and real-world materials; lighting attributes; associations between CAD or other design application model elements and real-world light sources; camera positions; or geographical coordinates, and wherein said one or compute nodes are capable of creating said renderings based at least in part upon said specifications.

74. The apparatus of claim 67 wherein said design visualization apparatus is capable of publishing said renderings to one or more web pages.

75. The apparatus of claim 67 wherein said design visualization apparatus is capable of outputting said renderings to one or more viewing devices.

76. The apparatus of claim 67 further comprising one or more web servers capable of outputting said renderings to said first device and one or more viewing devices.

77. The apparatus of claim 67 further comprising one or more compute nodes coupled to said design visualization apparatus by a local computer network; where said design visualization apparatus is capable of delegating rendering tasks to said one or more remotely coupled compute nodes and said one or more compute nodes coupled by said local computer network; and wherein said design visualization apparatus is capable of load balancing rendering tasks between said compute nodes.

78. The apparatus of claim 67 wherein said design rendering system is capable of monitoring said design and/or design parameters for one or more updates, and processing said updates at least in part by parsing or reparsing said design and/or design parameters if said update is detected.

79. The apparatus of claim 67 wherein said design visualization system is capable of querying a CAD or other design application for said design and/or design parameters.

80. The apparatus of claim 67 wherein said renderings are output in a format selected from the group comprising: still images, a sequence of images comprising an animation, a presentation file, a file format suitable for an interactive media delivery platform, a website, or a website that is capable of allowing interactive viewing.

81. The apparatus of claim 67 wherein said design visualization system further comprises a storage manager capable of storing a relational database and/or one or more files, and wherein said design visualization system is capable of communicating said stored relational database or files to said compute nodes for use in creating said renderings.

82. The apparatus of claim 67 wherein said design visualization system further comprises one or more workgroup managers capable of managing said compute nodes.

83. The apparatus of claim 67 wherein said design visualization system is capable of delegating to said compute nodes and assigning a number of said nodes to employ for a project based at least in part upon criteria selected from the group comprising:
subscription level of a user; system latency; network throughput, or one or more characteristics of a rendering task.

84. The apparatus of claim 67 wherein said design visualization system further comprises an annotation tool capable of adding comments to said renderings.

85. The apparatus of claim 67 wherein said design visualization system is capable of outputting renderings to one or more second devices and wherein said design visualization system is capable of accepting edits to said designs and/or design parameters from said second devices.

86. The apparatus of claim 67 wherein said design visualization system is capable of improving a visual quality of one or more said renderings of a first view if said second device is viewing said first view, and wherein said design visualization system is capable of storing said improved quality view and employing said improved quality view as a starting quality view for further viewings of said first view.
